(19) United States
(12) Patent Application Publication
(10) Pub. No.: US 2003/0088442 A1
(43) Pub. Date: May 8, 2003

(54) Inventory management system and method

(76) Inventors: Martin W. Michael, King of Prussia, PA (US); Daphne C. Bogert, Wallingford, PA (US)

Correspondence Address: John F. Letchford, Klehr, Harrison, Harvey,, Branzburg & Ellers, 260 South Broad Street, Philadelphia, PA, 19102, US

(21) Appl. No.: 10/278,500

(22) Filed: Oct. 23, 2002

Related U.S. Application Data
(60) Provisional application No. 60/343,641, filed on Oct. 23, 2001.

(51) Int. Cl. G06F 17/60

(52) U.S. Cl. 705/3; 705/22

(57) ABSTRACT

A method for managing a main inventory of items across a distributed mobile work force, wherein each worker has a mobile computing device which includes a full complement of inventory management functions. Each mobile worker manages their own sub-inventory of items and a local database is stored on the mobile computing device containing a list of the items in the sub-inventory. As the worker distributes items from and receives items into the sub-inventory, the local database is updated by recording each transaction. The local database is synchronized with a main database containing a list of the main inventory such that any transactions performed on the sub-inventory are recorded in the main database and reflected in the main inventory.

### CROSS REFERENCE TO RELATED APPLICATIONS

This application claims the benefit of U.S. Provisional Application Serial No. 60/343,641 filed Oct. 23, 2001.

### FIELD OF THE INVENTION

The present invention relates in general to a system and method for tracking inventory in an environment in which workers and inventory are mobile and distributed across a wide geographic area. More particularly, the present invention relates to a system and method for tracking pharmaceutical samples in such an environment.

### BACKGROUND OF THE INVENTION

The distribution of pharmaceutical samples is the primary and the most expensive marketing methodology currently practiced by the pharmaceutical industry. Industry estimates place the annual cost of sampling at nearly $8 billion. This number is made up primarily of two factors: the actual cost of the drug and the cost to logistically disperse the samples to the prescribing health care provider. With so many drugs being distributed, the opportunity for loss, errors, and theft is tremendous. In 1987, the problem of drug diversion was so bad that the U.S. Congress enacted the Prescription Drug Marketing Act of 1987 (PDMA). This law mandated strict guidelines for the control, disbursement, shipment, and handling of all prescription drugs, with a particular emphasis on controlling the handling of samples. The Food and Drug Administration (FDA) has since issued compliance guidelines that must be adhered to under penalty of law.

As a result of the compliance guidelines, many pharmaceutical companies have turned the PDMA into a paperwork nightmare. But close analysis reveals that the PDMA is really a stringent mandate that the pharmaceutical companies follow the same basic inventory accounting system that most other industries already use for the common movement of inventory between locations. The only difference being that the FDA added strict guidelines for signature capture to assure accountability and has mandated strict audit procedures to assure follow-up. However, these rules are little different than giving a grocery store clerk their own cash drawer, asking a trucker to obtain a signature on a bill of lading, or the annual counting of inventories for accounting purposes. With the movement of billions of dollars of inventory through the system, and little accountability after it leaves the warehouse, it is a wonder that the pharmaceutical companies had not already made controlling this inventory a top business priority. Unfortunately, many companies have accepted the price of the paperwork as a simple cost of doing business.

The difficulty is in the fact that a pharmaceutical company has thousands of representatives and controlling inventory is a major logistical and technical problem. Current enterprise inventory systems, such as Oracle®, SAP®, and others, are not well-suited to a mobile work force. Many companies have produced mobile solutions to allow these systems to be used from the field, but this creates another problem. Few companies find it acceptable to have hundreds of mobile workers completing transactions that directly affect their life-blood inventory system. And in the case of the pharmaceutical companies, these systems cannot address all of the details of the PDMA.

Attempting to integrate these various systems into a single inventory management system has been extraordinarily difficult and time-consuming. These problems have caused the typical pharmaceutical company to delay automation of a PDMA compliance system. Unfortunately for the industry, the FDA is not waiting and the compliance is strictly enforced. Most companies have implemented paper-based systems, while others have attempted to use hybrid systems, to become PDMA compliant. The end result has been a drastic decrease in field productivity.

In existing systems, every time a pharmaceutical company ships drugs to a distributor, the distributor brings that inventory into their own inventory system. This process is duplicated again when the inventory is moved from the distributor to the pharmacy. The process of moving the inventory from the warehouse to the representative is the same, with a few allowances for automating the data transfer.

Several attempts to address these problems have been articulated, but these proposals do not solve the entire problem. For example, U.S. Pat. No. 5,628,530 relates to a method and system for tracking demographic data on drug samples. This patent calls for the distribution of the drug sample by a pharmacy, not by a doctor, as well as requiring the use of either a multi-part paper form or a smart card. Similarly, related U.S. Pat. Nos. 5,832,449 and 6,055,207, also require distribution of a sample by a pharmacy. None of these patents illustrate tracking a pharmaceutical sample from the manufacturer to the doctor to the patient.

U.S. patent Application Publication No. 2002/0013787 relates to a method for automated sample tracking from a doctor to a patient and generation of a corresponding prescription for a regular supply of the sample drug. This method does not address the step of transferring the sample from the pharmaceutical company representative to the doctor.

In relation to expanding the concept of the present invention beyond the pharmaceutical industry to a more generalized mobile distributed inventory management system, a few additional patents are noteworthy. U.S. Pat. No. 5,869,819 relates to a system and method for tracking objects bearing Uniform Resource Locator (URL)—encoded bar code symbols. In this system, a wireless device is used to scan the barcode, which then uses the URL to access delivery information about the coded object.

U.S. Pat. No. 6,070,793 describes a system and method for tracking the delivery of goods, in which each item in the system has its own barcode. For example, the following barcodes are scanned in order: the driver, the delivery vehicle, the customer's location, and the goods to be delivered. Such extensive placement of barcodes on objects unrelated to the goods themselves (e.g., the customer's location) is onerous at best.

U.S. patent Application Publication No. 2002/0010661 relates to a distribution system for transferring a plurality of items from a distribution center to a customer. This system includes the use of a separate delivery device and retail device, both of which are capable of reading barcodes. The delivery device identifies the items, maintains a delivery record of a transfer of the items to the customer, and includes a data entry apparatus to enter transfer information, such as an electronically captured signature. The retail device identifies the items and maintains a receipt record of the transfer of the items. This system maintains a separate delivery database and retail database. However, there is no single, integrated database for tracking items entirely through the system.

An advantage exists, therefore, for a solution to address the complexities of PDMA field inventory, management, and compliance involving the implementation of a separate inventory system dedicated to field personnel. Rather than inventory being distributed to the sales force and written off of the books, it should be transferred from one perpetual inventory system to another, each with its own accountability, and management tools designed for the appropriate worker that interacts with it. While this does Such a solution possesses several advantages.

1. The field inventory system restores field inventory accountability.

2. The representative can take a stronger ownership of his or her own inventory control, with the proper tools to manage it.

3. PDMA compliance is addressed by managing the inventory system rather than a separate compliance tracking system that adds little value.

4. The discrepancies of a field inventory system can be managed and isolated for quick resolution and increased accountability.

5. Cross-referencing the drug distributions from a company's master inventory system to the field inventory system can be completed quickly, allowing discrepancies to be localized quickly.

6. A properly designed system allows the representative to increase productivity rather than lose time in paperwork and inventory management.

7. Items in the field inventory system can be reclaimed as a company asset on the accounting books.

It will be appreciated that similar benefits will also be realized by adapting the present system and method to other applications or industries where precise and reliable inventory tracking is desirable and/or mandated by law.

### SUMMARY OF THE INVENTION

A method for managing a main inventory of items across a distributed mobile work force, wherein each worker has a mobile computing device, includes a full complement of inventory management functions, such as receiving items, disbursing items, replenishing items, counting items, and transferring items between workers. Each mobile worker manages their own sub-inventory of items and a local database is stored on the mobile computing device containing a list of the items in the sub-inventory. As the worker distributes items from and receives items into the sub-inventory, the local database is updated by recording each transaction. The local database is synchronized with a main database containing a list of the main inventory, such that any transactions performed on the sub-inventory are recorded in the main database and reflected in the main inventory.

A method for automatically tracking the distribution of a pharmaceutical product sample from pharmaceutical company representatives to doctors begins with marking the sample with an automatic identification code. The sample is scanned with a scanning device to read the automatic identification code a first time when the representative receives the sample from the pharmaceutical company. The sample is scanned with the scanning device a second time when the representative gives the sample to the doctor. The doctor signs for receipt of the sample on the scanning device, which stores the doctor's signature. Lastly, the representative synchronizes the scanning device with a central database, so that the pharmaceutical company can track the sample from the company to the doctor. In one embodiment of the present invention, the sample is marked with a barcode and the scanning device is a mobile computing device equipped with a barcode scanner.

Other details, objects and advantages of the present invention will become apparent as the following description of the presently preferred embodiments and presently preferred methods of practicing the invention proceeds.

### BRIEF DESCRIPTION OF THE DRAWINGS

For a better understanding of the present invention, reference is made to the following detailed description of an exemplary embodiment considered in conjunction with the accompanying drawings, in which:

FIG. 1 is a flow diagram showing an overview of how pharmaceutical samples and information are distributed;

FIG. 2 is a flow diagram illustrating the information flow in a preferred embodiment of the present invention;

FIG. 3 is a flow diagram illustrating the synchronization process between the user and the main database;

FIG. 4a is a screen display for logging into a software application executing the present invention;

FIG. 4b is a screen display showing recent notifications;

FIG. 4c is a screen display showing notification history;

FIG. 4d is a screen display showing notification detail;

FIG. 5a is a screen display showing data entry fields for entering health care provider information during a disbursement transaction;

FIG. 5b is a screen display showing data entry fields for entering product information during a disbursement transaction;

FIG. 5c is a screen display showing a review of the information entered during a disbursement transaction;

FIG. 5d is a screen display for entering notes during a disbursement transaction;

FIG. 5e is a screen display for capturing a signature during a disbursement transaction;

FIG. 6a is a screen display for entering information to search a disbursement history;

FIG. 6b is a screen display showing the results of a disbursement history search;

FIG. 7a is a screen display showing data entry fields for a receiving transaction by a representative;

FIG. 7b is a screen display showing data entry fields for product information during a receiving transaction;

FIG. 7c is a screen display showing a review of the information entered during a receiving transaction;

FIG. 7d is a screen display for entering notes during a receiving transaction;

FIG. 8 is a screen display showing an inventory balance for a representative;

FIG. 9 is a flow diagram of the steps involved in creating a replenishment request;

FIG. 10a is a screen display showing data entry fields for the recipient of a replenishment transaction;

FIG. 10b is a screen display showing data entry fields for product information during a replenishment transaction;

FIG. 10c is a screen display showing a review of the information entered during a replenishment transaction;

FIG. 10d is a screen display for entering notes during a replenishment transaction;

FIG. 11a is a screen display for entering information to search a replenishment history;

FIG. 11b is a screen display showing the results of a replenishment history search;

FIG. 12 is a flow diagram of the steps involved in a representative to representative inventory transfer;

FIG. 13a is a screen display showing data entry fields for a representative to representative inventory transfer;

FIG. 13b is a screen display showing a review of the information entered during a representative to representative inventory transfer;

FIG. 13c is a screen display for entering notes during a representative to representative inventory transfer;

FIG. 13d is a screen display for capturing signatures during a representative to representative inventory transfer;

FIG. 14 is a flow diagram of the steps involved in an inventory reconciliation;

FIG. 15a is a screen display showing data entry fields for an inventory reconciliation;

FIG. 15b is a screen display showing a review of the information entered during an inventory reconciliation;

FIG. 15c is a screen display for entering notes during an inventory reconciliation;

FIG. 15d is a screen display for capturing a signature during an inventory reconciliation;

FIG. 16a is a screen display for entering information to search a reconciliation history;

FIG. 16b is a screen display showing the results of a reconciliation history search;

FIG. 17 is a flow diagram of the steps involved in an inventory adjustment transaction;

FIG. 18a is a screen display showing data entry fields for an inventory adjustment transaction;

FIG. 18b is a screen display showing a review of the information entered during an inventory adjustment transaction;

FIG. 18c is a screen display for entering notes during an inventory adjustment transaction;

FIG. 18d is a screen display for capturing a signature during an inventory adjustment transaction;

FIG. 19a is a screen display for entering information to search an inventory adjustment history; and

FIG. 19b is a screen display showing the results of an inventory adjustment history search.

### DETAILED DESCRIPTION OF A PREFERRED EMBODIMENT

The preferred embodiment described herein primarily relates to the pharmaceutical industry. However, it is possible to use the same system and method in other industries containing large numbers of mobile workers distributing items from a coordinated inventory. Therefore, the discussion of the system and method in relation to the pharmaceutical industry should only be viewed as one example of how the present invention may be implemented, and not as limiting the present invention to the pharmaceutical industry.

Overview

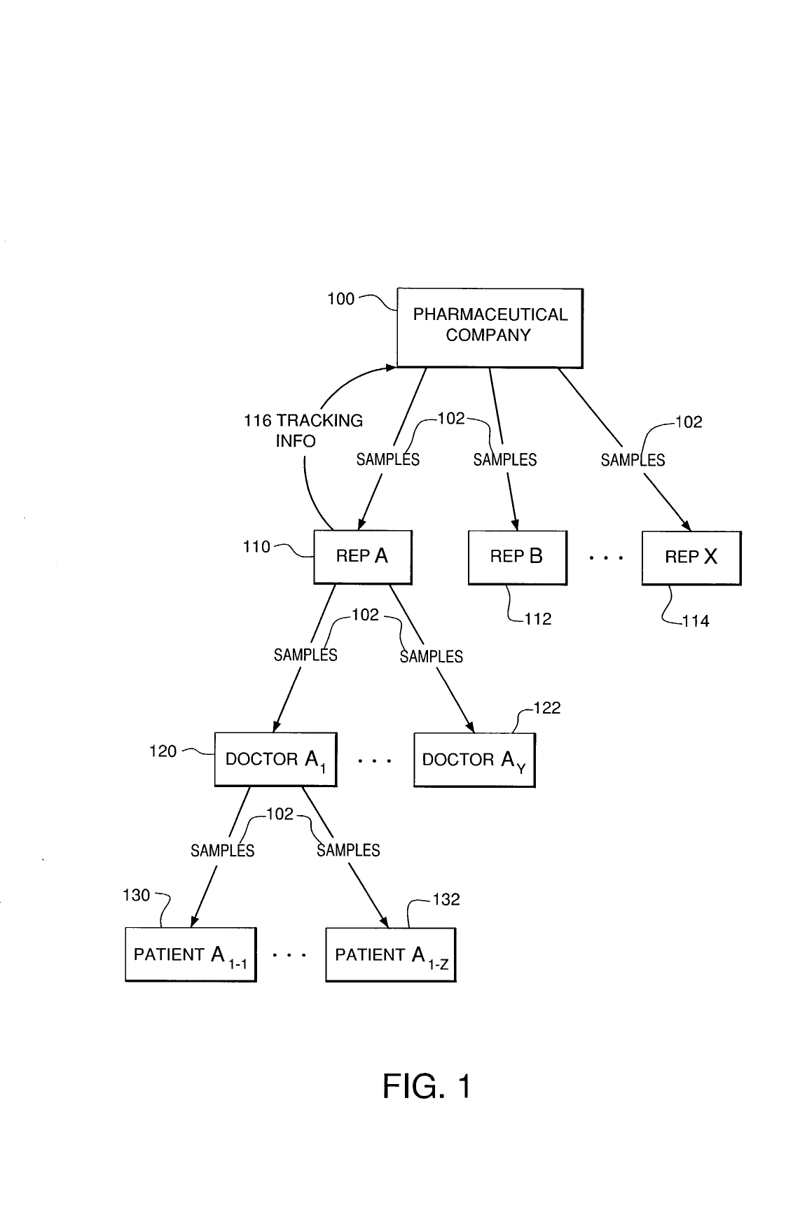

Referring now to FIG. 1, a pharmaceutical company 100 distributes a plurality of samples 102 to its field representatives 110, 112, 114. Under the Prescription Drug Marketing Act of 1987 (PDMA), each representative 110, 112, 114 is required to provide tracking information 116 to the pharmaceutical company 100 as to which doctors received the samples and on what dates.

Doctors 120, 122 receive the samples 102 from the representative 110, and must sign for the samples. The doctors 120, 122 then distribute the samples 102 to their patients 130, 132.

FIG. 1 very simplistically shows the numbers of representatives 110, 112, 114; doctors 120, 122; and patients 130, 132 involved in the distribution tree for a single pharmaceutical company 100. In practice, the numbers involved are quite large, and the body of information 116, 124 that must be maintained under law also becomes rather large. The size of this body of information creates problems in that it must all be captured and transmitted to the proper locations. In a paper-based system, it would be fairly easy to incorrectly record and/or misplace some of the information.

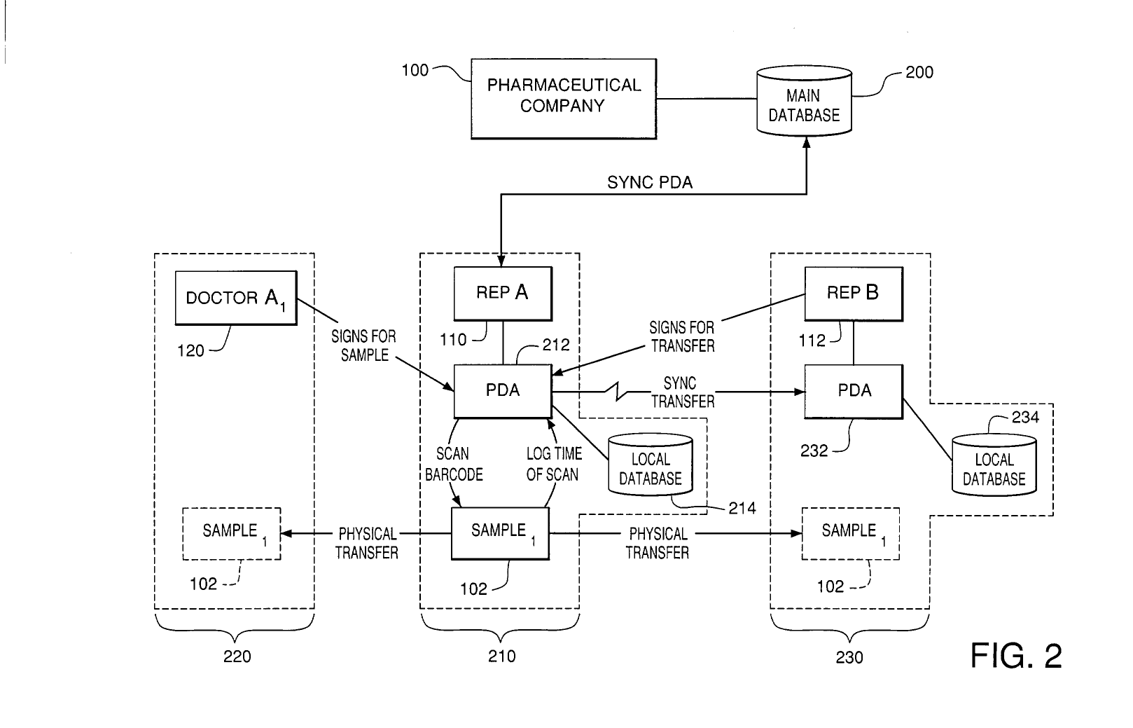

FIG. 2 shows how the system and method of the present invention can be utilized to automate the process of distributing the samples 102 and recording the related tracking information. The pharmaceutical company 100 maintains a single main inventory database 200 that is used to track all of the samples and their related information. The main database 200 can be based on an Oracle® or Microsoft® SQL Server backend, or any other standard ODBC-complaint database. The selection of database technology inherently determines the technologies used at the core business logic and interface levels. It is traditionally easier to implement a system using a suite of tools and components from a single manufacturer (for example, a combination of a Microsoft® SQL Server backend, database objects, and C# and ASP.Net objects). While different technology sets can be intermixed, doing so adds complexity and cost to the system.

A first pharmaceutical company representative 110 (hereinafter referred to as “Rep A”) is the representative that receives the sample 102 from the pharmaceutical company 100, which is within Rep A's “universe” of controlled items 210. Rep A 110 also has a personal digital assistant (PDA) 212, which is the primary means of Rep A's interaction with the pharmaceutical company's main database 200. The PDA 212 can be any type of hand-held computing device that can be synchronized with another computing device. As illustrated and described below, a preferred embodiment of the present invention operates on a PDA running the PocketPC (Windows CE®) operating system. This should not be interpreted as limiting the present invention to any particular operating system or PDA; the system and method of the present invention can be implemented on any operating system and PDA.

As will be described in further detail below, Rep A 110 uses the PDA 212 to scan the barcode of the sample 102 via an attached barcode reader, which can be built into the PDA 212 or removably connected thereto. Information relating to the sample 102 (such as product type, lot number, expiration date, etc.) is logged into a local database 214 stored on the PDA 212, along with the date and time that the scan was performed. This simple procedure (scanning the barcode of the sample 102 with the PDA 212) is used by Rep A for a variety of tasks including receiving inventory, distributing samples to doctors, transferring inventory to another representative, and counting inventory on hand. The local database 214 is updated after any transaction that accesses its contents.

It is to be noted that while the preferred embodiment of the present invention utilizes barcodes, the system and method described herein will function similarly when used in conjunction with other types of automatic identification technologies, such as magnetic stripes, radio frequency identification tags, microdots, and nanotechnologies. While the preferred embodiment utilizes automatic identification technologies for simplifying data entry, it is also possible to use the present invention without such technologies, by relying on manual input means such as drop-down lists or manual entry fields.

At regular intervals, Rep A 110 will synchronize the PDA 212 with the pharmaceutical company's main database 200, thereby transferring the contents of the local database 214 to the main database 200. While synchronizing the PDA 212 after regular intervals (approximately once even 24-48 hours) is preferred, any form of synchronization can be used to achieve the same results, including synchronization via real-time wireless communications. Because most of the transactions in the main database 200 are unique to a single representative, the interaction and collision space within the main database 200 is limited to those situations involving a single representative. This characteristic of the main database 200 permits the use of multiple representatives accessing the same main database without the typical problems that could otherwise plague a large database being accessed by numerous individuals.

When distributing a sample 102 to a Doctor A₁ 120, Rep A 110 scans the barcode of the sample 102 with the PDA 212. In addition to the physical transfer of the sample 102, Doctor A₁ 120 also signs for the sample 102 using a signature capture function of the PDA 212. The sample 102 then enters Doctor A₁'s “universe” of items 220.

Another function of the present invention is the simple transfer of inventory between two different representatives. To transfer a sample 102 from Rep A's “universe” 210 to Rep B's “universe” 230, Rep A first scans the barcode of the sample 102 with the PDA 212. As part of the transfer function, Rep B 112 signs for the transfer on PDA 212, which in turn synchronizes the transfer information with Rep B's PDA 232, storing the transfer information in local database 234. When either Rep A or Rep B synchronizes their PDA with the main database 200, the transfer will be recorded on the main database 200.

While PDAs 212, 232 are shown in FIG. 2 as a preferred method for representatives interacting with the main database 200, it is also possible to access the main database 200 via a World Wide Web (“Web”) browser interface. Such a Web interface (not illustrated) functions similarly to the PDA interface shown and described herein, and uses application server logic to perform the database manipulations.

Synchronization

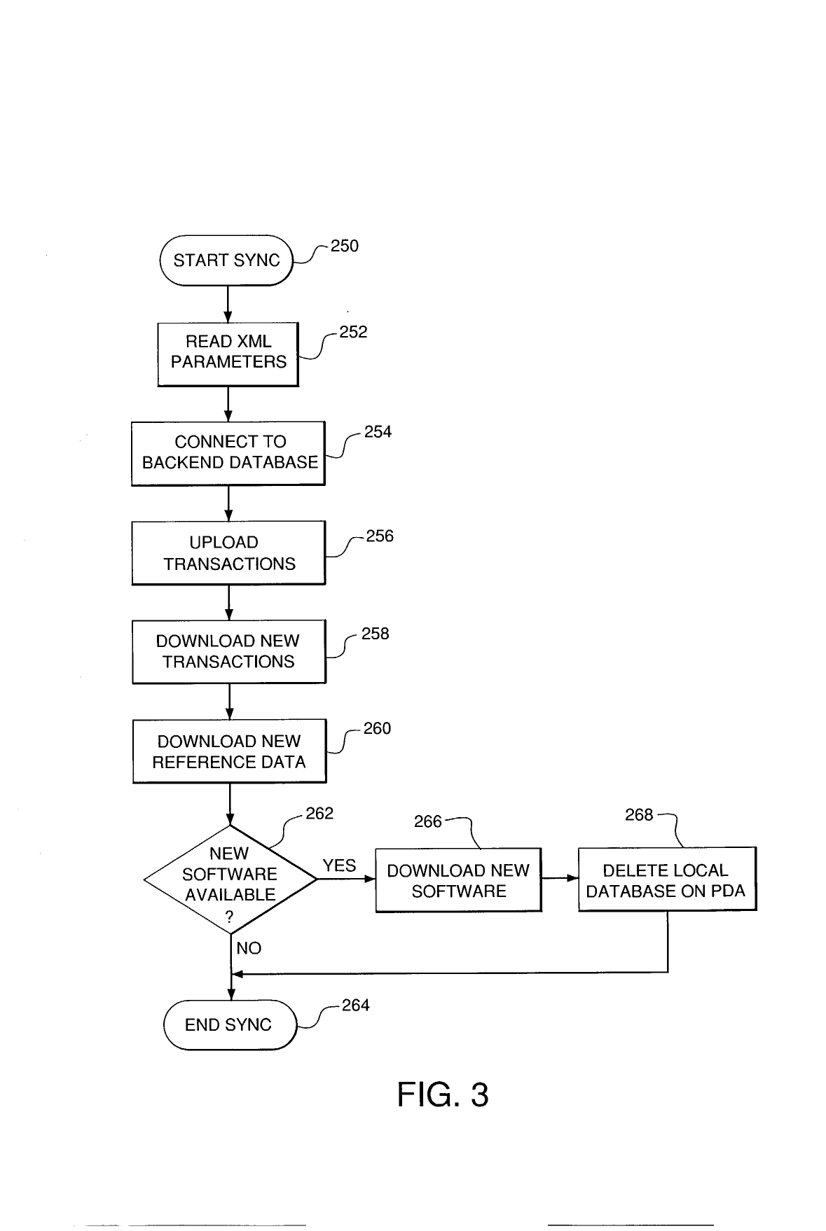

FIG. 3 shows a flow diagram for the synchronization process between a user's PDA 212 and the pharmaceutical company's main database 200. The process begins at step 250, when the user initiates the synchronization function of the PDA 212. Once the PDA has connected to the pharmaceutical company's computer system, a set of Extensible Markup Language (XML) parameters are read (step 252). Next, the connection to the main backend database 200 is made (step 254).

Once connected to the main database, any transactions performed by the user that have been stored in the local database 214 of the PDA 212 are uploaded to the main database (step 256). Any new transactions relating to the user's subset of the main database are then downloaded to the PDA (step 258). If there is any new reference data relating to any of the products in inventory, it is downloaded to the PDA in step 260.

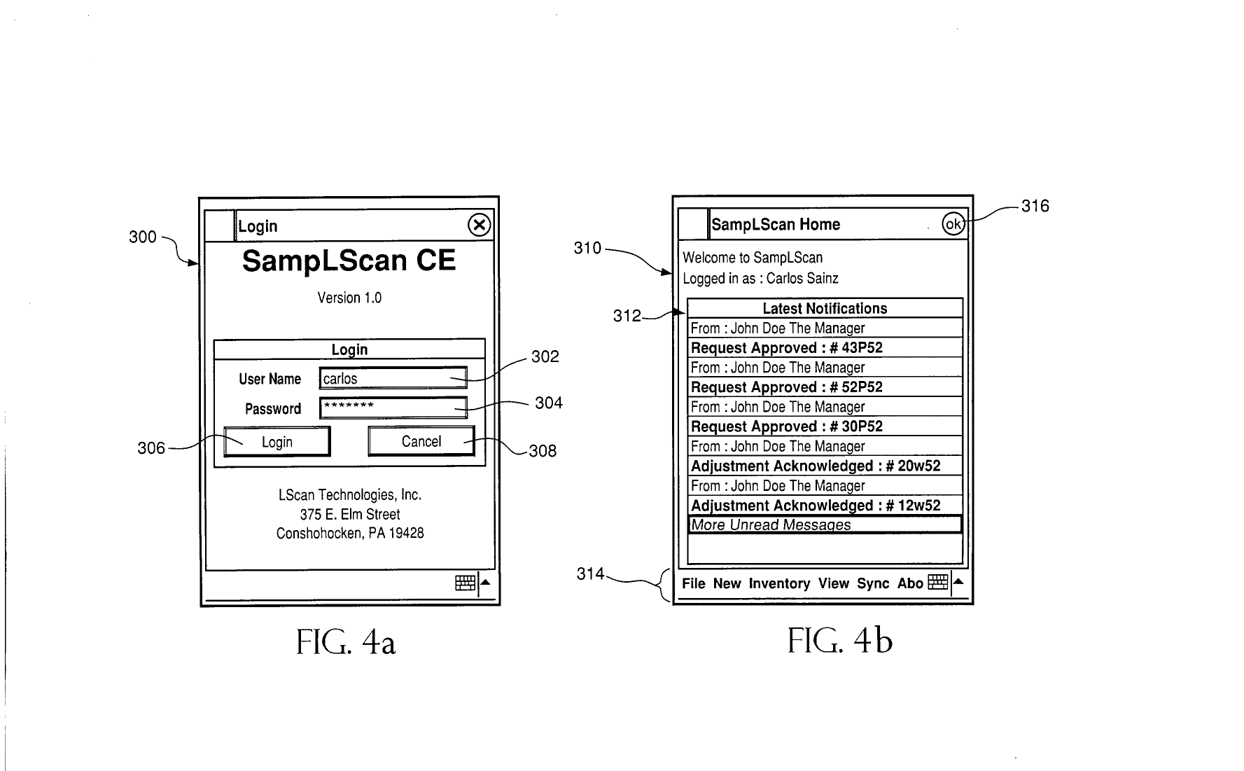

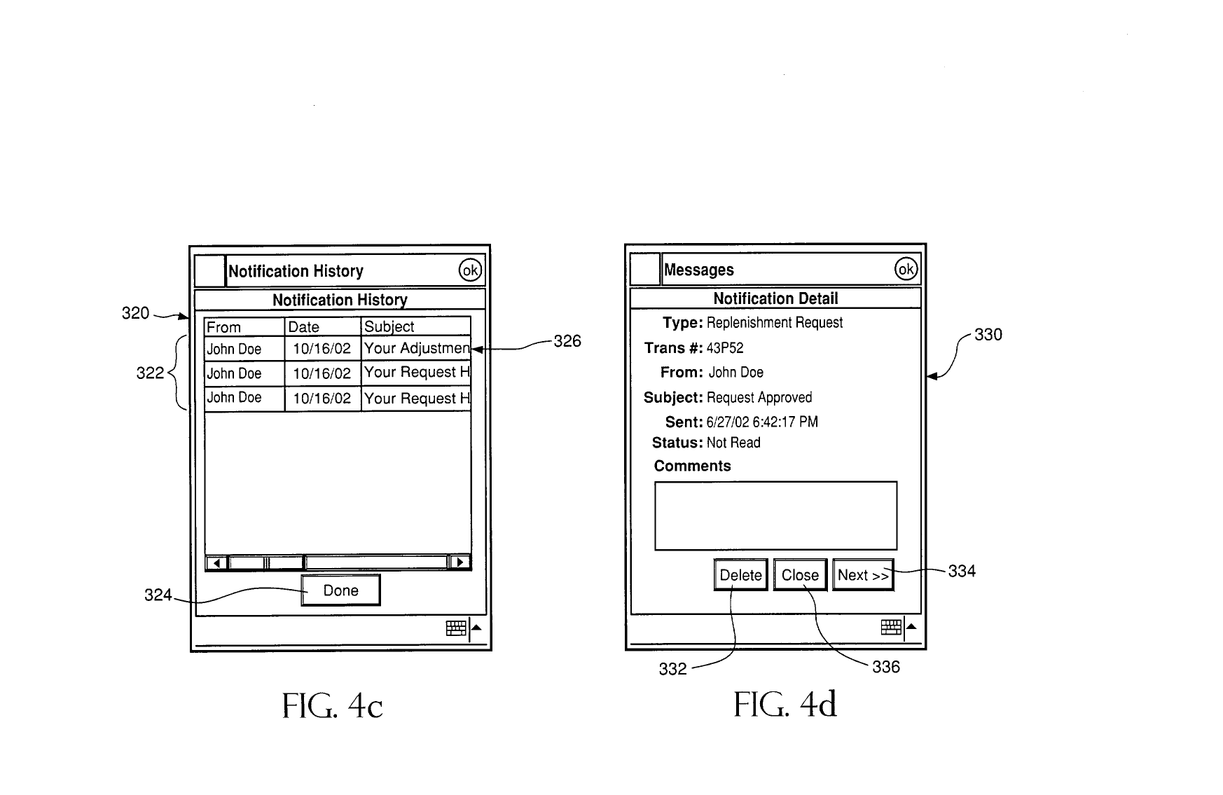

Next, a check is made to determine if there is a new version of the software available (step 262). If not, the synchronization process ends (step 264) and the application terminates. If there is new software available, it is downloaded to the PDA (step 266), the local database 214 is deleted from the PDA (step 268), and the synchronization process ends (step 264) and the application terminates. The local database 214 is deleted in step 268 because with a software update, there may be changes to the database structure, which would require reformatting of the local database. Instead of placing this potentially data-corrupting task on the PDA, a new local database will be created when the user logs into the system with the new software. (See the discussion below in connection with FIG. 4a.)

System Login

FIG. 4a shows a login screen 300 used to access the application. The login screen 300 includes a user name entry field 302 and a password entry field 304. After the user has entered his or her user name and password, clicking the Login button 306 will process the login information, and will authenticate the user against the main database 200. If no local database 214 exists on the PDA 212 at the login time, a local database will be created, based upon the user's subset of the main database 200. If the user clicks the Cancel button 308, the application terminates.

Once the user is properly logged in to the application, home page 310 is displayed (FIG. 4b). The most recent messages received by the user are displayed in a list 312. From the Home page 310, the user can access all of the functions of the application via a menu bar 314. The user can return to the Home page 310 at any time during the execution of the application by closing the present function by clicking on the “OK” button 316.

The following function choices are available from the menu bar 314:

| Menu | Menu Item |
|---|---|
| File | Exit |
| New | Disbursement |
| | Disbursement Return |
| | Replenishment |
| Inventory | Reconcile Inventory |
| | Adjust Inventory |
| | Receive Inventory |
| | Rep Transfer |
| View | Disbursement History |
| | Replenish History |
| | Reconcile History |
| | Adjustment History |
| | Receipt History |
| | Rep Transfer History |
| | Inventory Balance |
| | Notifications |
| About | About LScan |
| | About SampLScan |

When the user selects View->Notifications from the menu bar 314, a Notification History screen 320 is shown (FIG. 4c), containing a list 322 of the messages received by the user. When the user has finished viewing the messages, clicking on the Done button 324 returns the user to the Home page 310. To view one of the messages in detail, the user selects a single message 326, which is then displayed in a separate Notification Detail screen 330 (FIG. 4d). To delete the currently viewed message, the user clicks the Delete button 332. To view the next message in the list 322 directly on the detail screen 330 without returning to the screen 320, the user can click on the Next button 334. If there are no other messages in the list 322, then the Next button 334 will not appear on screen 330. When the user has finished viewing the messages, clicking on the Close button 336 returns the user to the Home page 310.

Disbursements and Orders

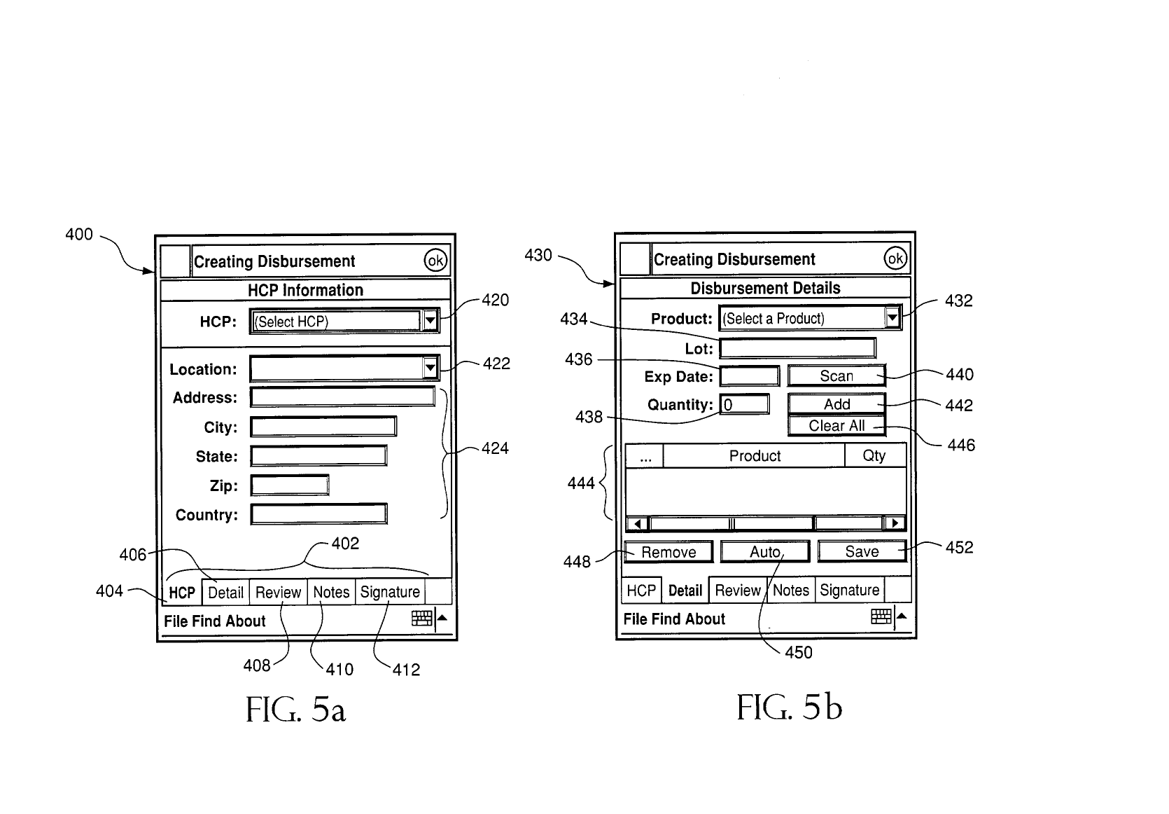

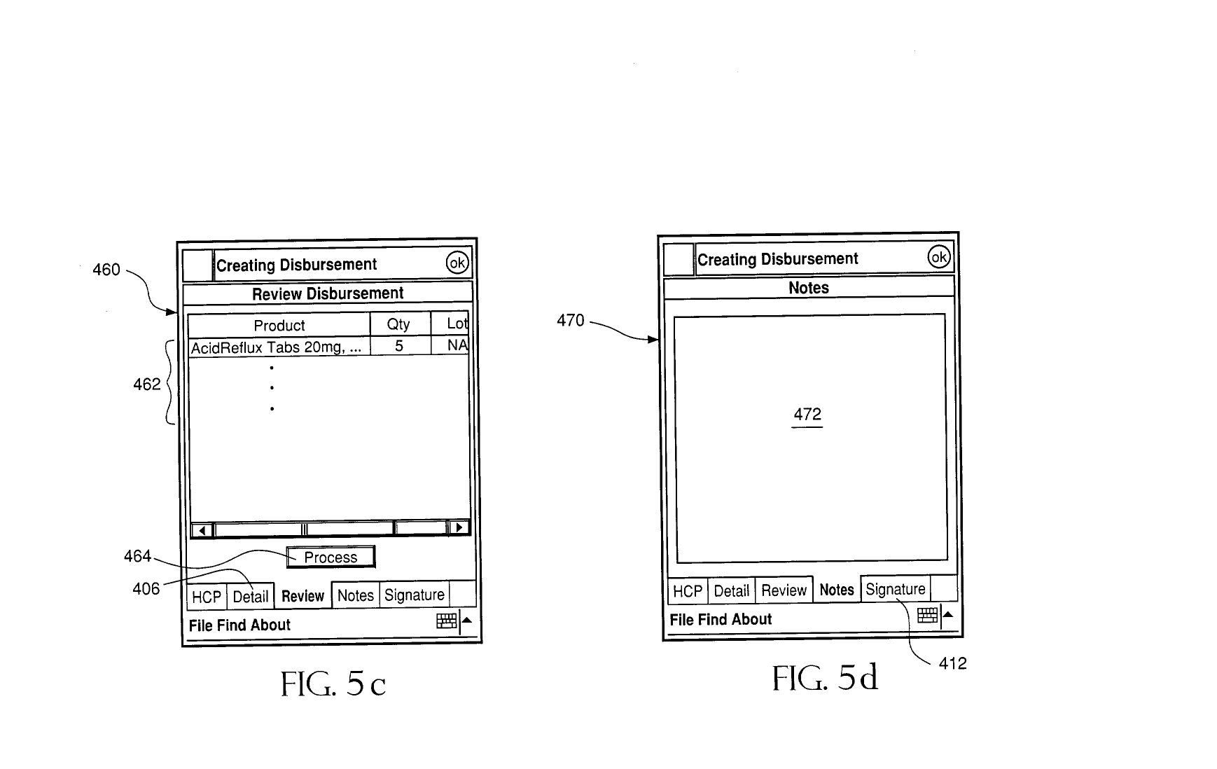

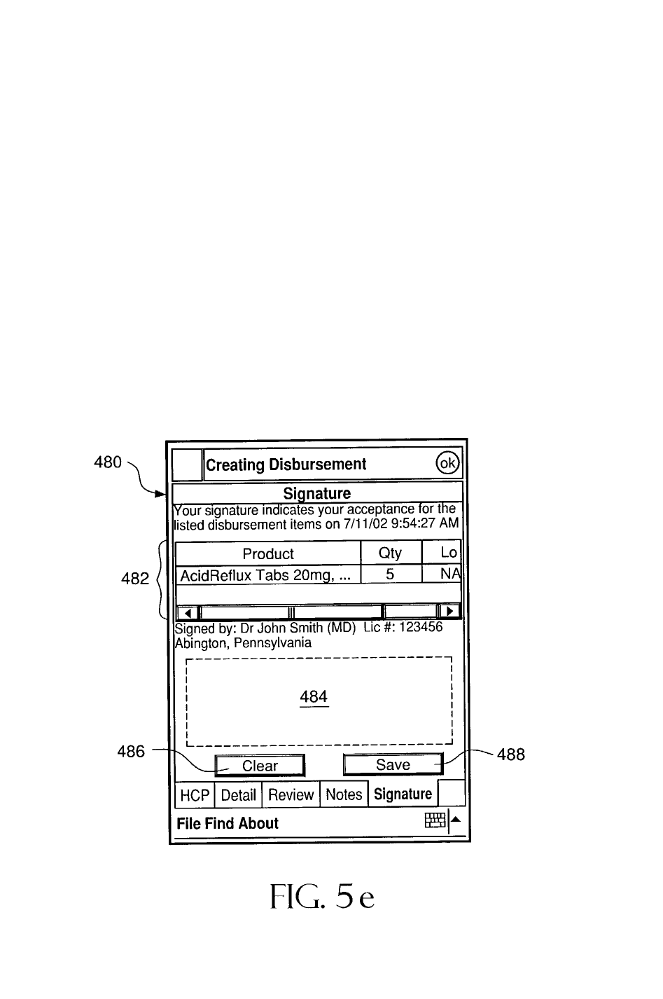

By selecting New->Disbursement from the menu bar 314 of FIG. 4b, the user will enter the sequence for creating a disbursement, as shown in FIGS. 5a-5e. The user first sees A Creating Disbursement information screen 400, which is used to enter information relating to the health care provider (HCP) who is receiving the sample. The term “HCP” as used herein refers to any individual authorized to dispense pharmaceutical samples, and is used interchangeably with the term “doctor.”

A set of tabs 402 is displayed on the screen 400, with the tab representing the present step of the disbursement process being highlighted. Tab set 402 preferably comprises an HCP tab 404, a Detail tab 406, a Review tab 408, a Notes tab 410 and a Signature tab 412, the functions of which are described below. The individual tabs 404-412 can be selected at any point during the disbursement creation process to either advance a step or return to a previous step. A drop-down list 420 is used to select the HCP. The list 420 is limited to those HCPs that are assigned to the user and that can receive samples. If the HCP has more than one location, the user will select the proper location for the disbursement via the drop-down list 422. Once the HCP, and location if necessary, are selected, the address information 424 is automatically filled in. After the HCP information has been entered, the user clicks on the Detail tab 406 to enter the product information and a Disbursement Details screen 430 appears (FIG. 5b). Screen 430 is used to enter the details about the sample to be given to the HCP. The details for a particular product may be entered manually by the user as follows. First, the product is selected from a drop-down list 432. Then the lot number, expiration date, and quantity are entered by the user into field boxes 434, 436 and 438, respectively, and are interpreted via the PDA's handwriting recognition software. The lot number 434 and expiration date 436 are not always required; each product 432 is flagged to determine whether or not this information is required.

Alternately, the user can click the Scan button 440 to activate the barcode scanner attached to the PDA. Once the scanner had been activated, the user scans the barcode on the sample packaging. The barcode is then parsed by the system and the product information 432-438 is automatically filled in. If the user scans an additional sample of the same product and the lot number 434 and expiration date 436 are the same, then only quantity field 438 will be updated.

After the product information has been entered, the user clicks the Add button 442, which results in the information being displayed in the current disbursement list 444. Clicking the Clear All button 446 will erase any of the data currently entered into the fields 432-438. If the user has scanned a product, clicking the Add button 442 is not necessary, as the scanning operation automatically adds the information to the list 444. In the event the user has insufficient inventory on hand to meet an individual disbursement entry (i.e., a single product 432, lot number 434, and expiration date 436 combination), the user will be alerted by the system, but can override the alert and distribute the available quantity.

Each individual product in the list 444 can be individually highlighted and manipulated. For example, clicking the Remove button 448 will remove the selected product from the list 444. Clicking the Auto button 450 will generate an automatic disbursement transaction for that product. An automatic disbursement is based upon past disbursement history of the same product to the selected HCP and determines the quantity to disburse, which is based upon system parameters for minimum and maximum quantities, as well as the number of past disbursements to be used in the calculation. Once the user has entered the information for all of the products to be disbursed, clicking the Save button 452 completes the entry step, and proceeds to the Review Disbursement screen 460 (FIG. 5c).

Screen 460 displays a list 462 of the products to be disbursed during the present transaction. If any of the information shown in the list 462 needs to be changed, clicking on the Detail tab 406 will return the user to the details screen 430. Once the user has reviewed this information for accuracy, the Process button 464 is clicked, leading the user to the Notes entry screen 470 (FIG. 5d). At screen 470, the user can enter any notes regarding the disbursement transaction via the standard PDA input methods, and the notes will be displayed in the text box 472. After any notes have been entered, the user clicks the Signature tab 412 to proceed to the last step of the disbursement transaction.

The Signature Capture or, simply, Signature screen 480 (FIG. 5e) displays a list 482 of the products to be disbursed to the HCP. The recipient of the products is required by the PDMA to sign for the samples, which can be done via the PDA's writing area and is displayed in a signature box 484. To clear the signature and re-sign for the disbursement, the Clear button 486 is clicked. In the event the user needs to go back and modify any part of the transaction, the signature box 484 will be automatically cleared out, and the user must re-sign for the now-modified transaction upon returning to the signature capture screen 480.

To complete the disbursement transaction, the user clicks the Save button 488, which processes the transaction in the local database and stores the date and time of the disbursement along with the recipient's signature to verify the transaction. During synchronization with the pharmaceutical company's main database, this transaction is added to the main database, and the HCP is sent an electronic mail message confirming the transaction. When the transaction is completed, the user is automatically redirected to the home page 310 (FIG. 4b).

In the event that the HCP is returning samples to the representative, a sequence of screens similar to FIGS. 5a-5e are used to return the product(s) to the representative's inventory.

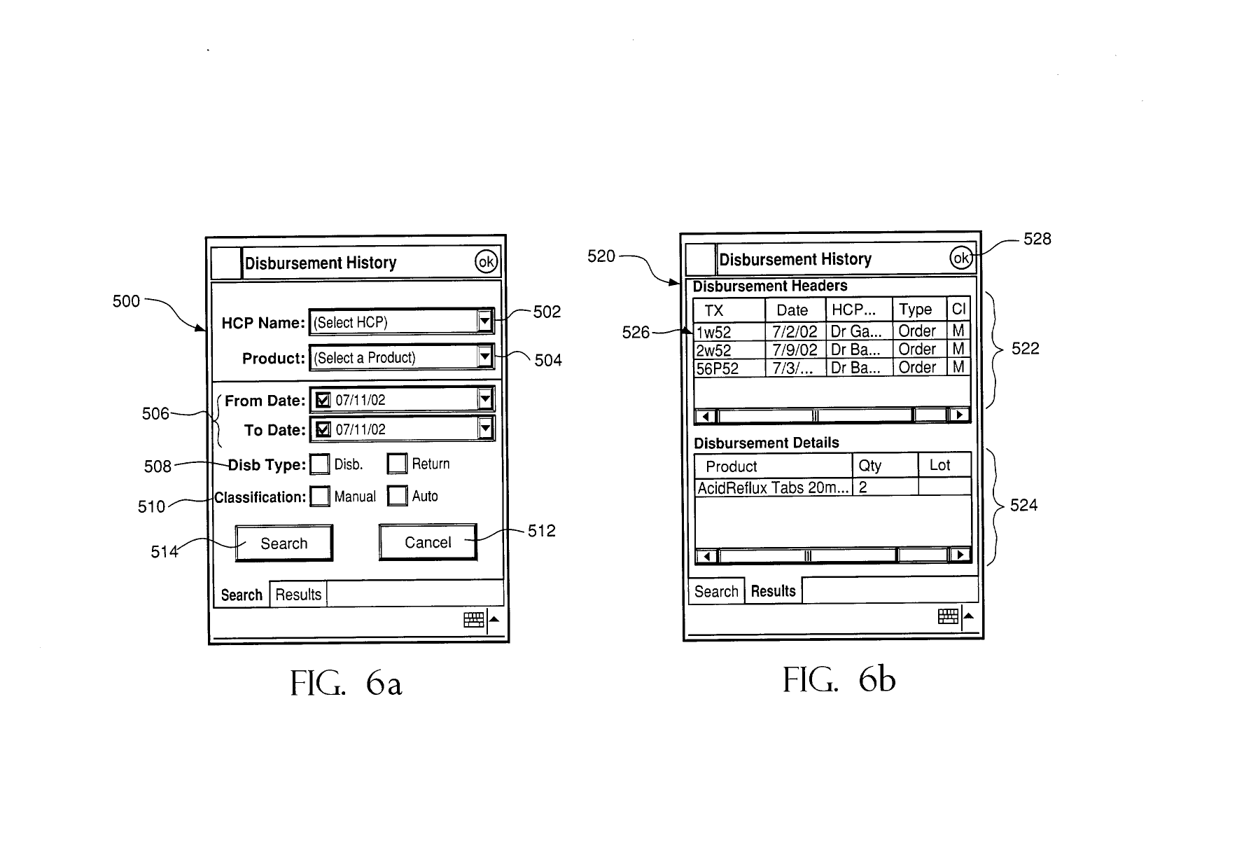

By selecting View->Disbursement History from the menu bar 314 on the Home page 310, the user is presented with a disbursement History search screen 500 shown in FIG. 6a. At screen 500 the user can review any previous disbursements as shown in FIGS. 6a and 6b. The Disbursement History search screen 500 (FIG. 6a) is used to enter criteria to search the database for particular disbursements made by the user. The user can search by HCP from a drop-down list 502, by product from a drop-down list 504, by disbursement date ranges 506, disbursement type 508, and/or classification 510. All of the fields 502-510 are optional; the user can search the disbursement history based upon any desired combination of criteria. Clicking the Cancel button 512 will clear out any information entered into the fields 502-510. When the user has specified the desired criteria, clicking the Search button 514 will execute the search in the database.

The results of the search are displayed in a Disbursement History results screen 520 (FIG. 6b), consisting of a header section 522 and a detail section 524. The header section 522 displays general information about all of the disbursements matching the search criteria. Selecting an individual disbursement entry 526 displays the details of that disbursement in the detail section 524. The user can return to the home page 310 by clicking on the “OK” button 528.

Receiving Inventory

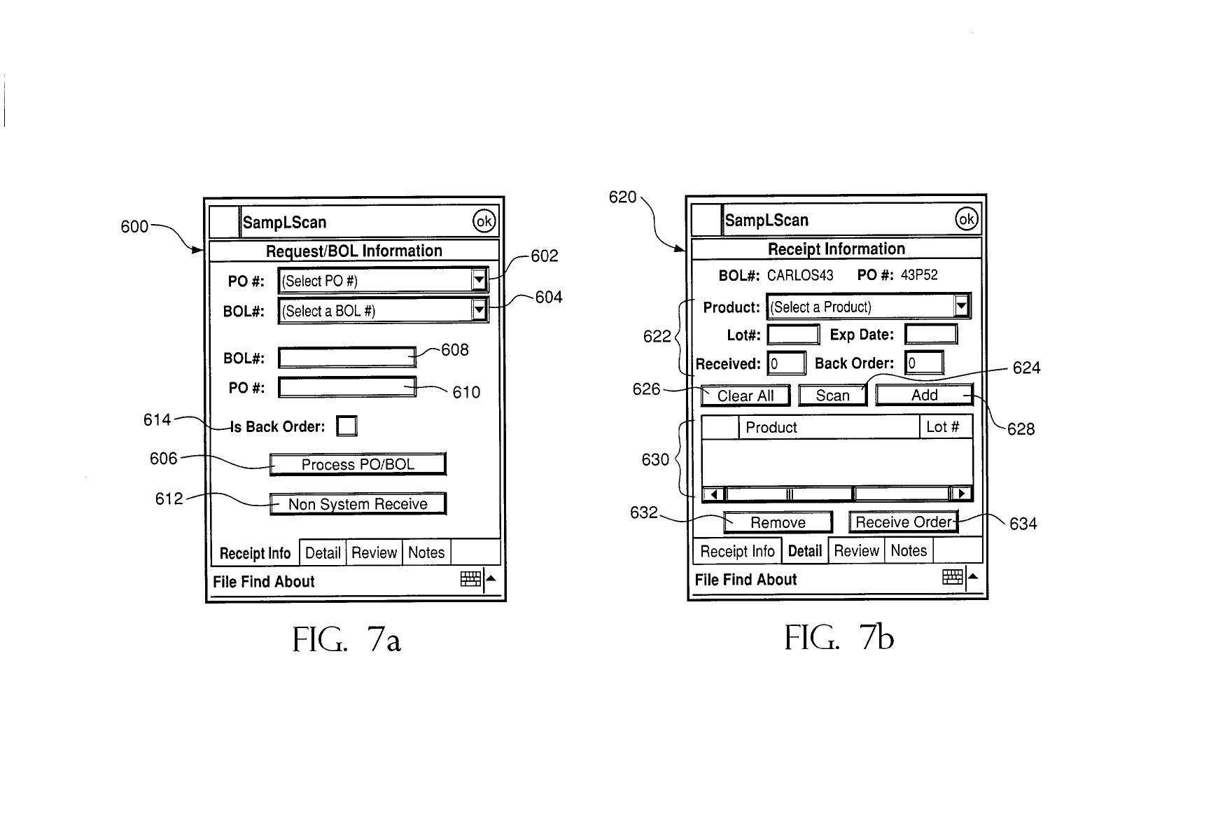

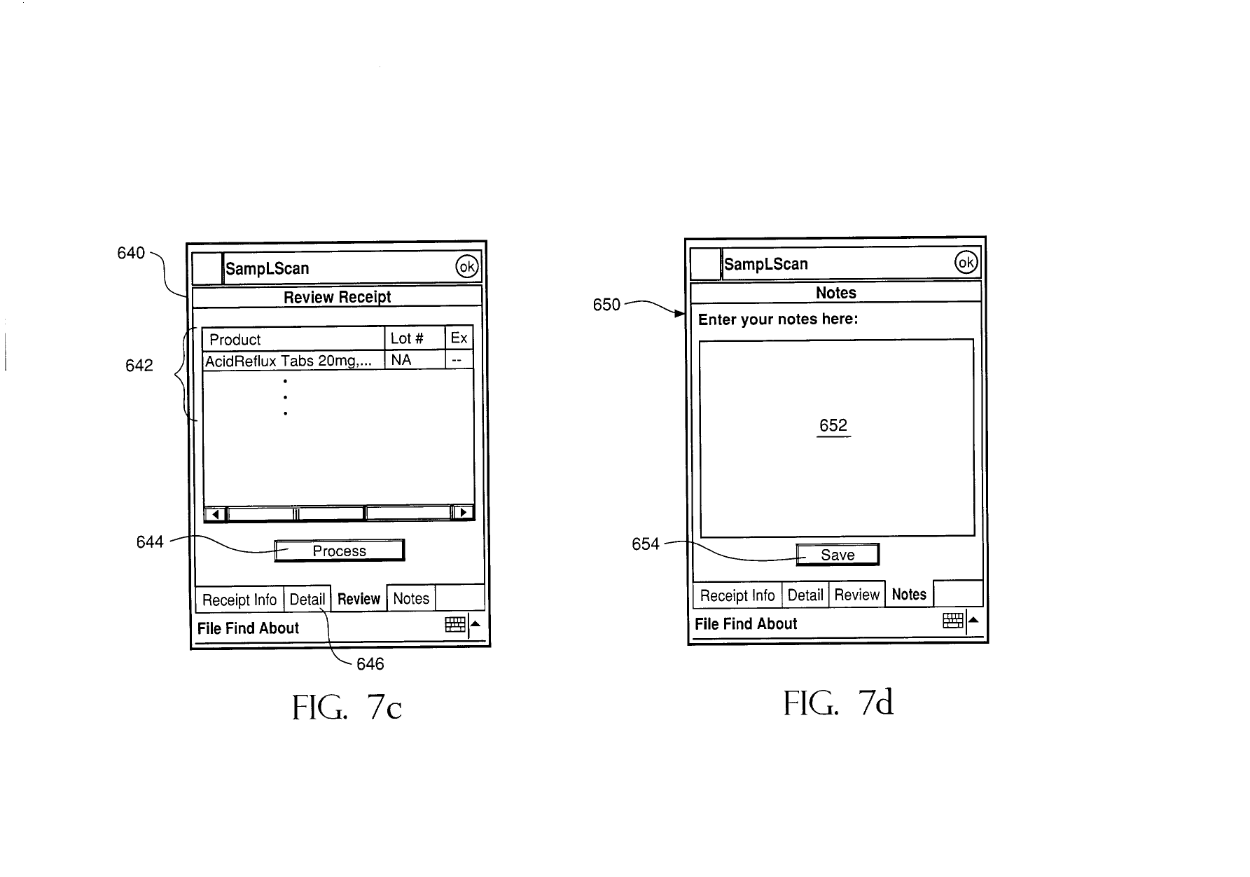

The sequence of steps for a representative to receive inventory from the pharmaceutical company are shown in FIGS. 7a-7d. This sequence is accessed by selecting Inventory->Receive Inventory from the menu bar 314 on the Home page 310. As shown in FIG. 7a, a Request/BOL (bill of lading) Information screen 600 contains a drop-down list 602 to select a purchase order number (PO#) and a drop-down list 604 to select a bill of lading number (BOL#). The drop-down lists 602, 604 are used when there is an existing and open order or a partially received order, in which case the information relating to the order will be stored in the local database. Once the proper information has been selected from either drop-down list 602, 604, the user clicks the Process PO/BOL button 606 to process the order.

If the representative receives items that she did not order (termed a “non-system order”), she will need to manually enter the bill of lading number in text box 608 or the purchase order number in the text box 610. Because a non-system order has, by definition, not been previously entered into the system, it is necessary to manually enter the information pertaining to that portion of the order. To process this type of order, the user clicks the Non-System Receive button 612.

The Is BackOrder checkbox 614 is selected if the order is both a system order and a backorder, which will make the appropriate adjustments to the database when the order is processed.

After button 606 or 612 is clicked, the user is presented with the Receipt Information detail entry screen 620, as shown in FIG. 7b. The user can enter the product information manually via the fields 622 or by clicking the Scan button 624, the user can scan the barcodes of the products to be received in a manner similar to that described above in connection with FIG. 5b, with the fields 622 being automatically filled in when a product is scanned. Clicking the Clear All button 626 will erase any data displayed in the fields 622. When the information for a product has been entered, the user clicks the Add button 628 which adds the product information to the received items list 630. If the user has scanned a product, clicking the Add button 628 is not necessary, as the scanning operation automatically adds the information to the list 630.

It is also possible for the list 630 to be pre-populated, based upon the bill of lading number 604, wherein the items that have been delivered to the representative have already been entered into the system.

Any individual item in the list 630 can be selected and remove from the list 630 by clicking the Remove button 632. To process the items in the list 630, the user clicks the Receive Order button 634. Additionally, the user can edit the information relating to an item in the list 630 by double-clicking on it.

The user is then shown the Review Receipt screen 640 (FIG. 7c), which includes a list 642 of the items to be received. If any of the information shown in the list 642 needs to be changed, clicking on the Detail tab 646 will return the user to the details screen 620. When the user clicks on the Process button 644, the notes entry screen 650 (FIG. 7d) is displayed. The user can enter any notes regarding the receiving transaction via the standard PDA input methods, and the notes will be displayed in the text box 652. After any notes have been entered, the user clicks the Save button 654 to complete the receipt of items. The system will compare the items received against the original order placed to determine whether all of the ordered items have been received, and will mark the order as closed (if all items have been received) or partially filled (if only some of the items have been received).

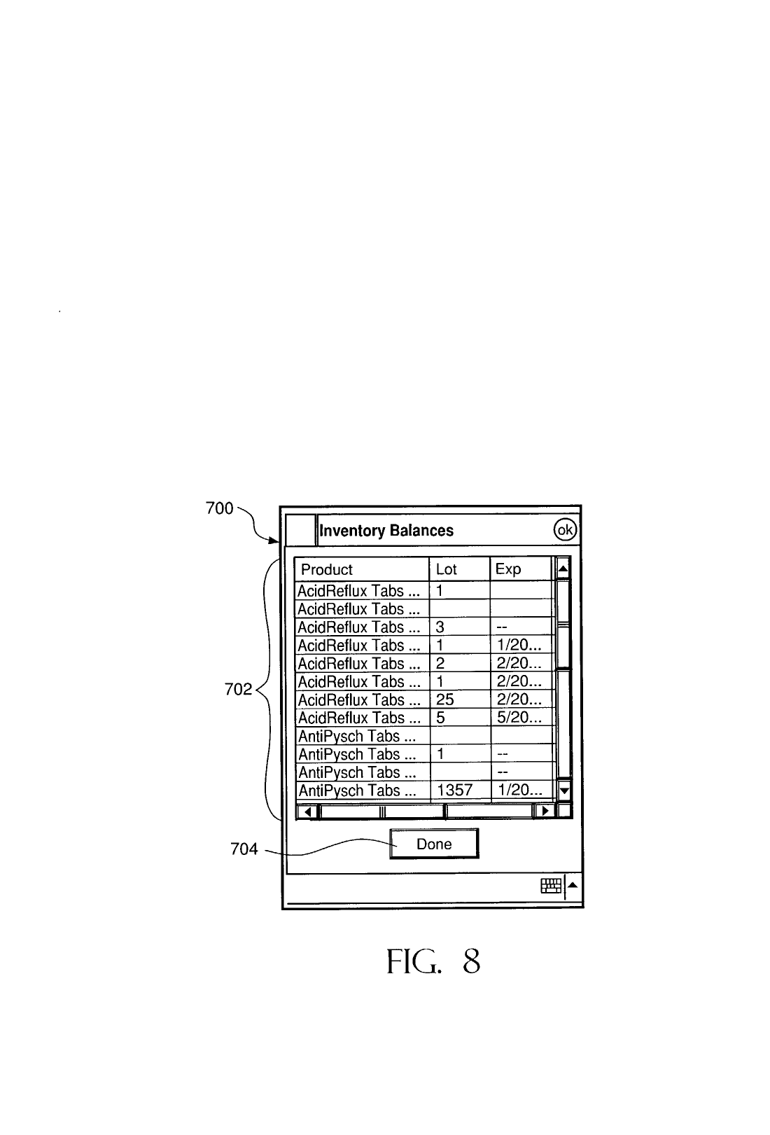

By selecting View->Inventory Balance from the menu bar 314 on the Home page 310, the user can review all of the items in his or her current inventory on an Inventory Balances screen 700, as shown in FIG. 8. Inventory balance screen 700 contains a list 702 of the items in the user's inventory. When the user has finished reviewing the list, he or she can click the Done button 704 to close the list and return to the Home page,310.

Replenishment

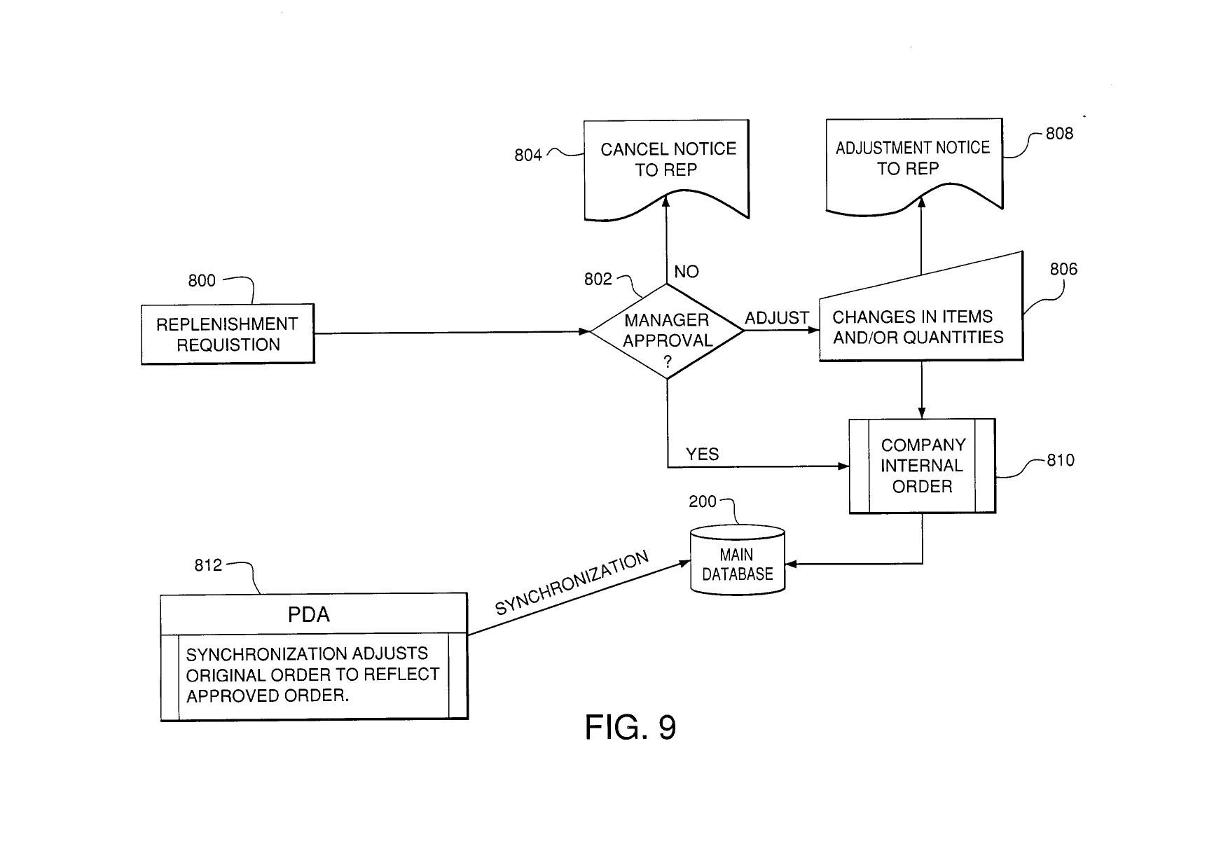

When a representative needs to reorder a particular sample for her inventory on hand, he or she follows a replenishment procedure as shown in FIG. 9. A replenishment request 800, created on the representative's PDA, is electronically presented to the representative's manager, who makes a decision 802 whether to approve the replenishment request. If the request is denied, the representative will receive notification of the denial at step 804.

If the manager approves the request, but not in its entirety, a product and/or quantity adjustment will be performed at step 806 and the representative will be notified of the change at step 808. If the manager approves the request as submitted or adjusts the quantity, the order is placed with the pharmaceutical company at step 810. When the representative synchronizes his or her PDA with the main database 200 at step 812, the original replenishment request 800 will be adjusted to reflect any changes made by the manager at step 806, and the local database will be updated accordingly.

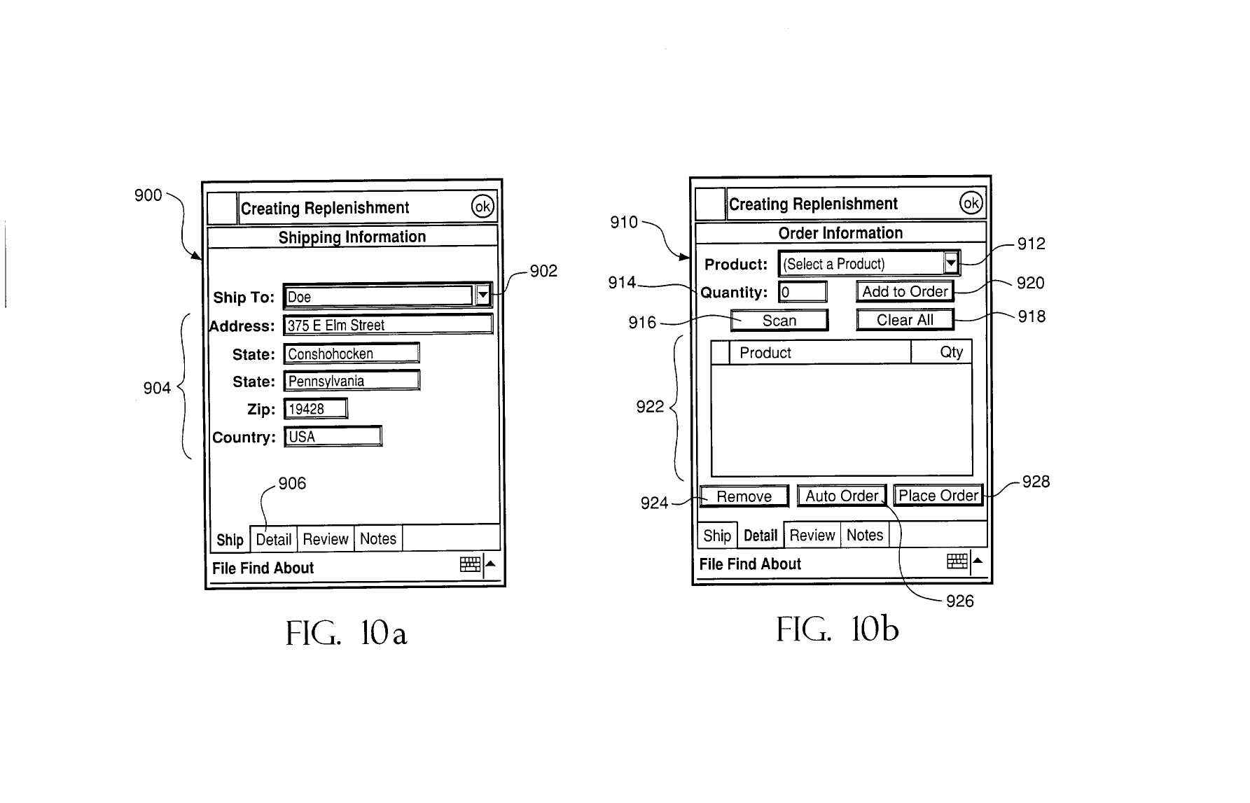

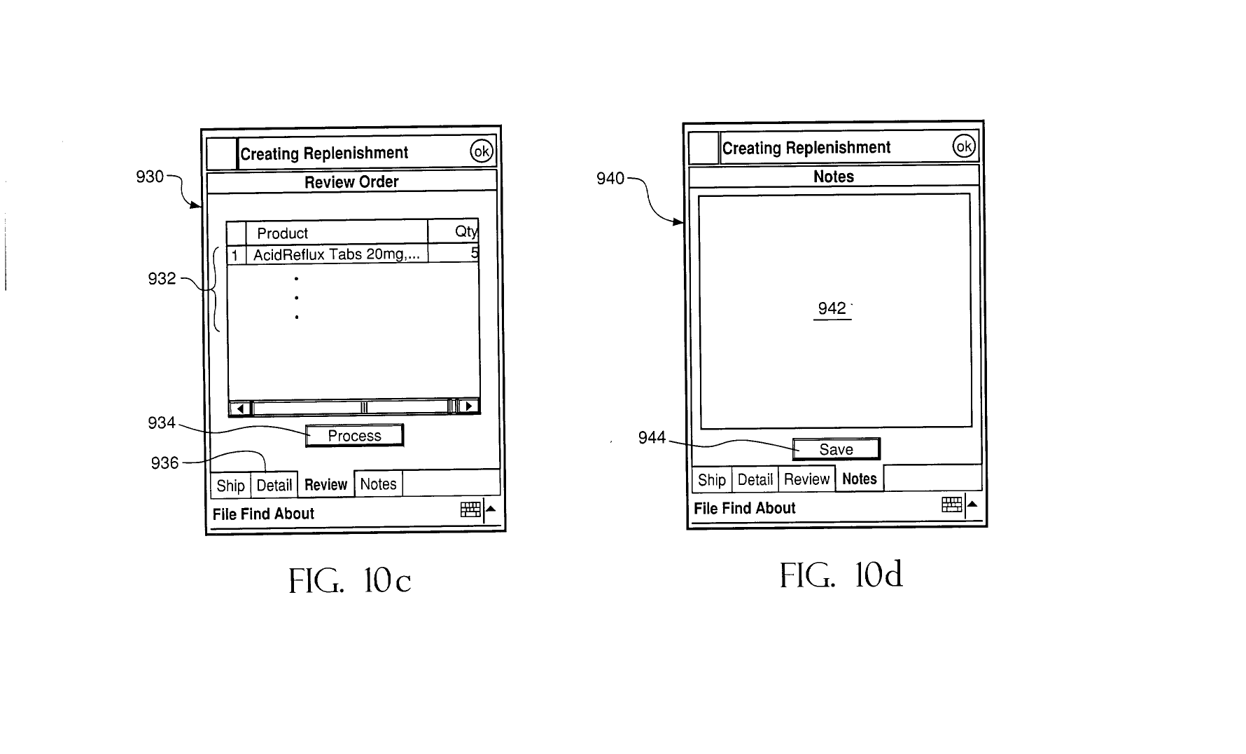

To create the replenishment request 800, the representative uses the sequence of screens shown in FIGS. 10a-10d, which are accessed by selecting New->Replenishment from the menu bar 314 of the Home page 310. Referring now to FIG. 10a, a Shipping Information screen 900 provides a drop-down list 902 for the user to select the desired shipping location for the replenishment order. Once a location is selected, the address information 904 will be automatically filled in. After the shipping information has been provided, clicking the Detail tab 906 takes the user to an Order Information entry screen 910 (FIG. 10b).

At screen 910, the product to be replenished can be selected from a drop-down list 912, and the quantity manually entered in field 914. Alternately, the user can click the Scan button 916 to scan the barcode of a product, which will automatically fill in fields 912 and 914 with the information relating to the scanned product. Clicking the Clear All button 918 will erase any information displayed in the fields 912, 914. To add the product to the replenishment request, the user clicks the Add to Order button 920, which will then display the product information in a list 922. Any individual item in the list 922 can be selected and removed from the replenishment request by clicking the Remove button 924.

Clicking the Auto Order button 926 will clear the list 922 of any items already present in the list, and will populate it with recommended order quantities based upon previous order history. Utilizing this function can save the user time, and takes advantage of the system's inherent database capabilities. Regardless of the method used to create the replenishment request, the list 922 will contain the products to be ordered, and clicking the Place Order button 928 will display a Review Order screen 930 (FIG. 10c).

Screen 930 contains a list 932 of the items to be ordered is shown for the representative's review. If any of the information shown in the list 932 needs to be changed, clicking on the Detail tab 936 will return the user to the details screen 910 of FIG. 10b. Once the user is satisfied with the replenishment request, clicking the Process button 934 will present the user with a Notes entry screen 940 (FIG. 10d). The user can enter notes about the replenishment request via the standard PDA input methods into a text box 942. After the user has entered his or her notes, clicking the Save button 944 records the replenishment request in the system and automatically returns the user to the home page 310.

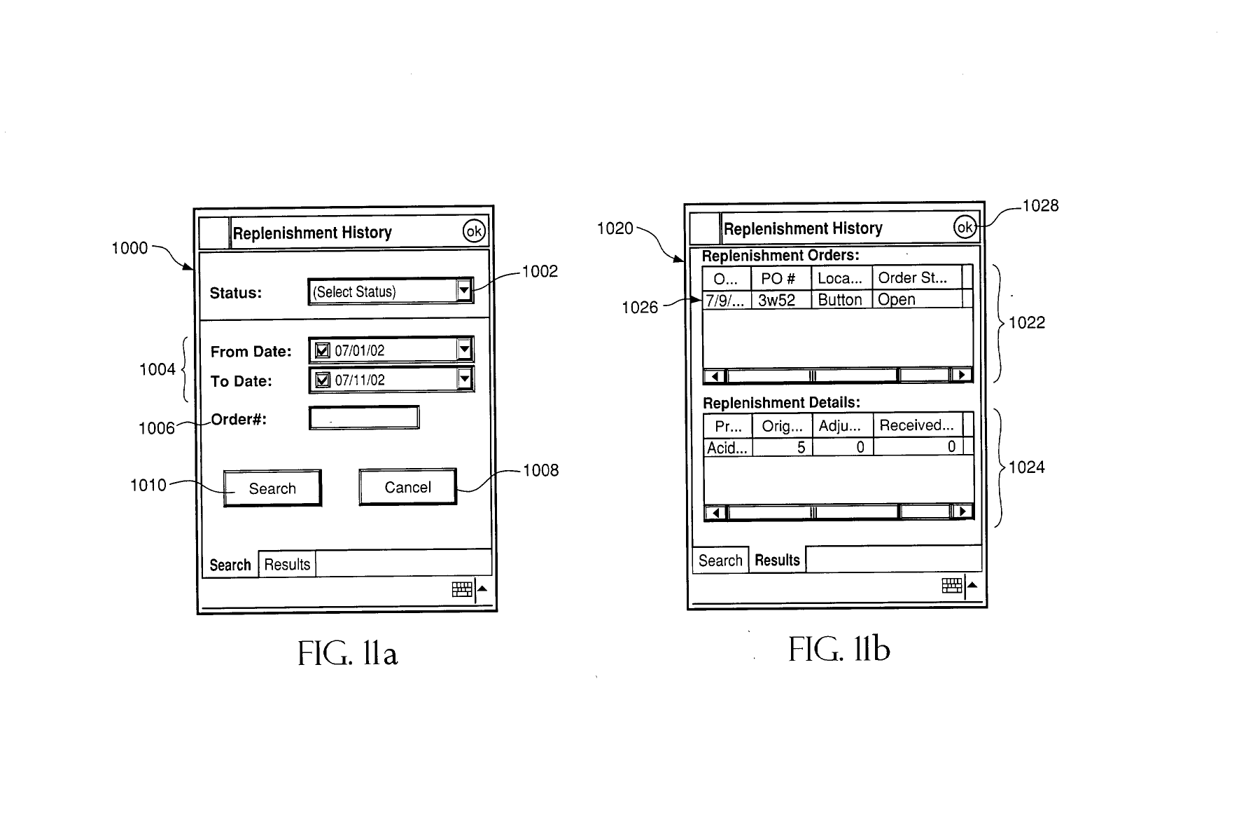

By selecting View->Replenish History from the menu bar 314 on the Home page 310, the user can review the history and status of their replenishment requests, as shown in FIGS. 11a and 11b. The Replenishment History search screen 1000 (FIG. 11a) is used to enter criteria to search the database for particular replenishment requests made by the user. The user can search by status of the order (e.g., open, partial, closed, rejected) from a drop-down list 1002, by replenishment request date ranges 1004, or order number 1006. All of the fields 1002-1006 are optional; the user can search the replenishment history based upon any desired combination of criteria. Clicking the Cancel button 1008 will clear any information entered into the fields 1002-1006. When the user has specified the desired criteria, clicking the Search button 1010 will execute the search in the database.

The results of the search are displayed in a Replenishment History results screen 1020 (FIG. 11b), consisting of a header section 1022 and a detail section 1024. The header section 1022 displays general information about all of the replenishment orders matching the search criteria. Selecting an individual entry 1026 displays the details of that replenishment order in the detail section 1024. The user can return to the home page 310 by clicking on the “OK” button 1028.

Representative to Representative Transfers

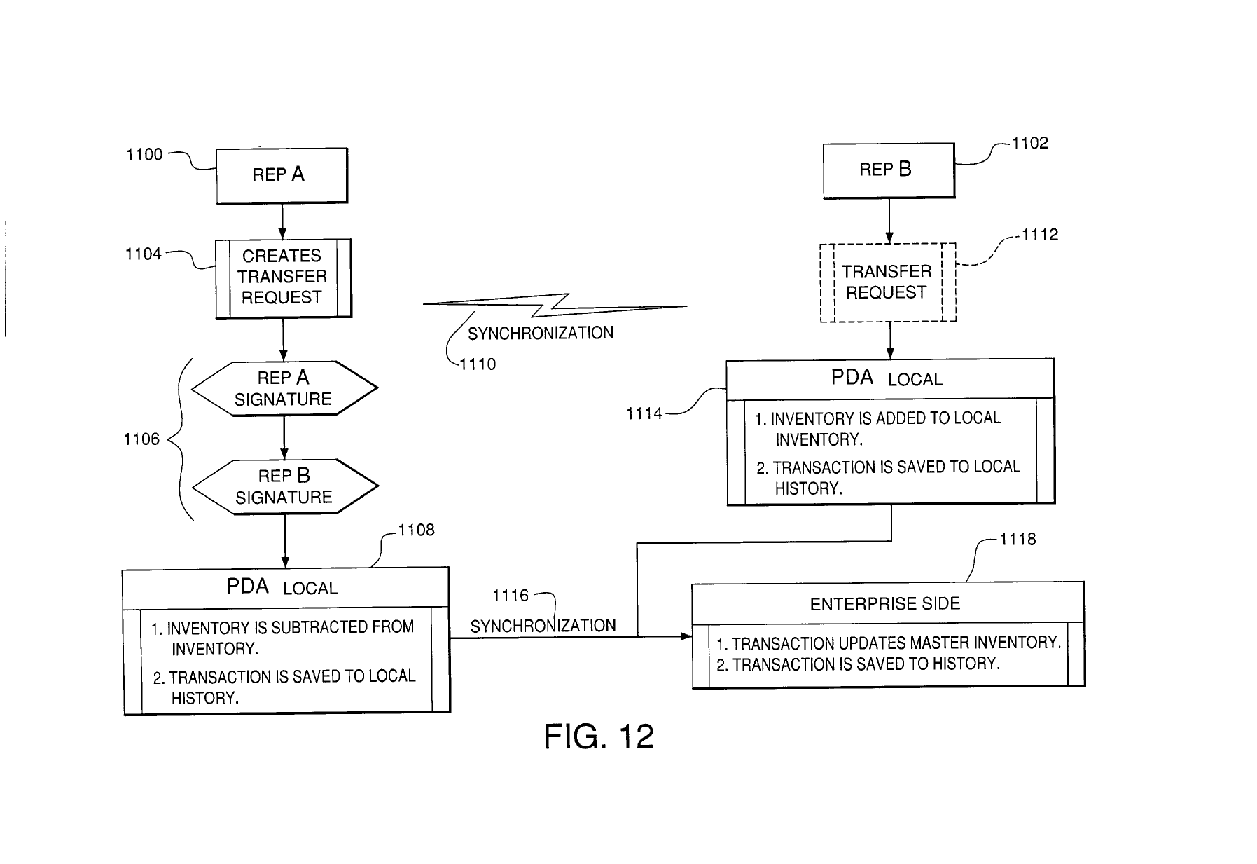

It is occasionally necessary for one representative to request inventory from another representative. The process involved in such a transfer is shown in FIG. 12, and follows the basic accounting of any sub-inventory transfer that moves inventory from one location to another. For the purposes of explanation, it is assumed that Rep A 1100 is providing a transfer of inventory to Rep B 1102.

Rep A creates a transfer request 1104 on his or her PDA. As part of the process, both Rep A and Rep B must attach their signatures to the transfer request, shown at step 1106. In step 1108, the transfer subtracts the inventory from Rep A while recording the transfer request in the local database of Rep A's PDA. At step 1110, Rep A and Rep B synchronize their PDAs by a wireless or infrared link.

After this synchronization, the local database on Rep B's PDA will store a copy of the transfer request (step 1112), and the inventory transferred from Rep A will be added to Rep B's inventory (step 1114). This transaction only needs to be recorded once in the pharmaceutical company's master database (to avoid recording a duplicate transfer), so the first representative to synchronize their PDA with the master database will accomplish this (step 1116). The master database will appropriately flag the transfer (step 1118), so when the second representative synchronizes their PDA with the master database, the transfer will not be recorded twice.

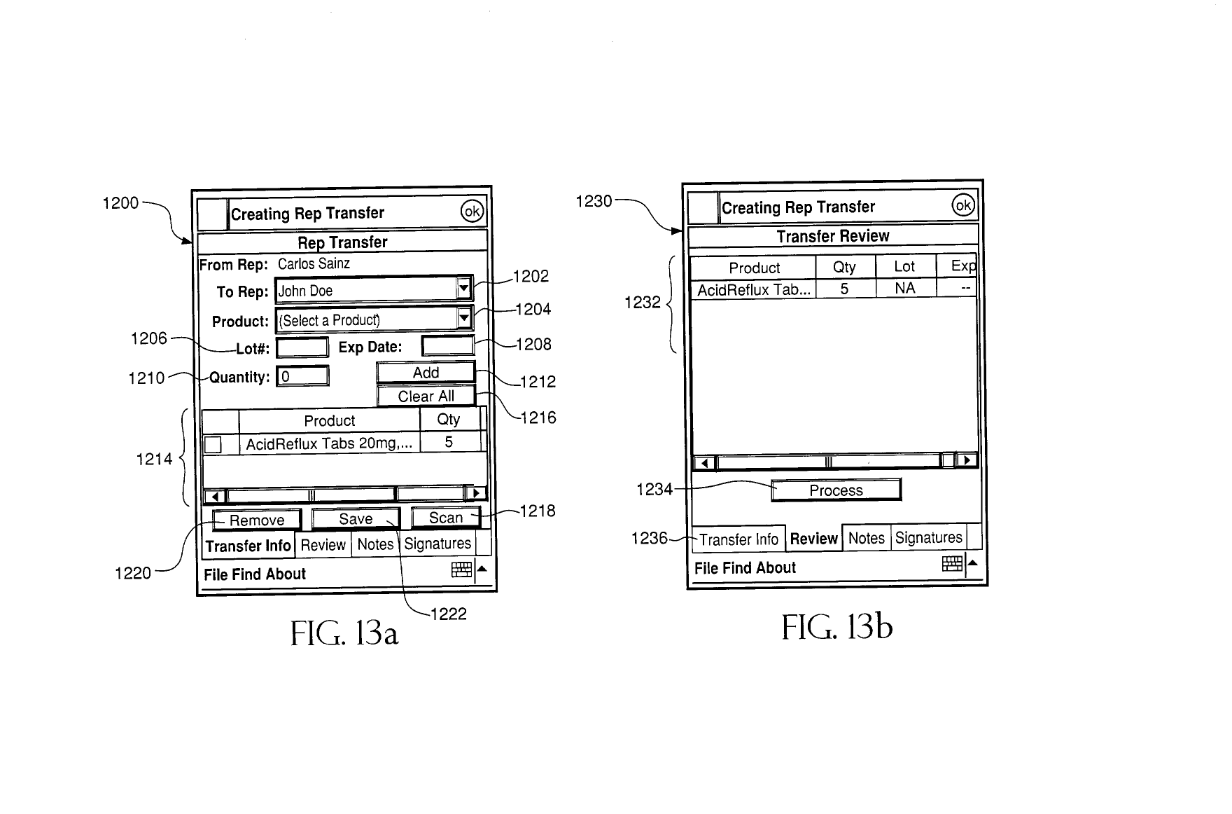

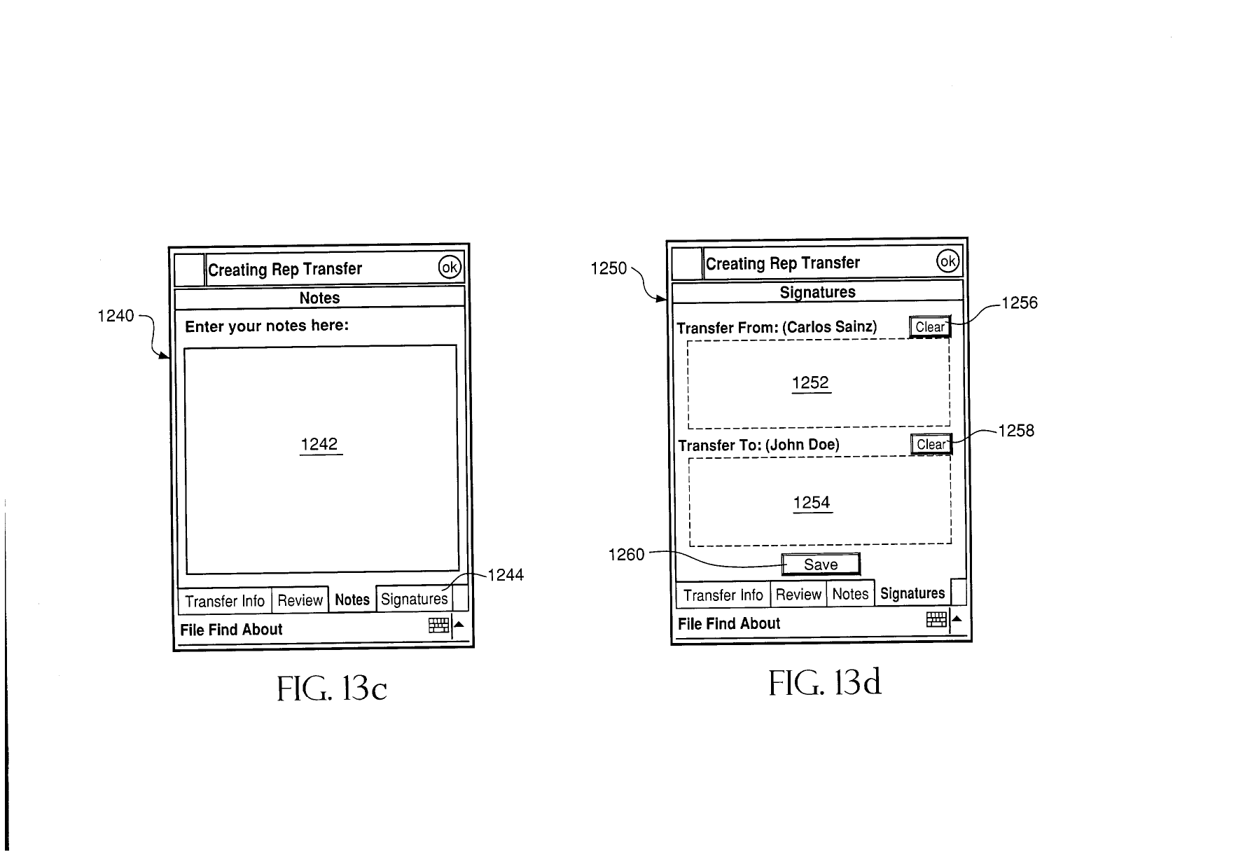

To create the transfer request, Rep A will use the sequence of screens shown in FIGS. 13a-13d, which are accessed by selecting Inventory->Rep Transfer from the menu bar 314 of the Home page 310. Referring now to FIG. 13a, a Rep. Transfer creation screen 1200 is used to enter the information relating to the transfer request. The representative who will receive the inventory is selected from a drop-down list 1202, and the product to be transferred is selected from drop-down list 1204.

After the product 1204 has been chosen, the lot number 1206, expiration date 1208, and quantity 1210 may be manually entered. After the product information has been entered, clicking on the Add button 1212 will place the product information into a list box 1214. Clicking the Clear All button 1216 will erase any information from the fields 1202-1210.

Instead of manually entering the product information 1204-1210, the user can click the Scan button 1218 to scan the barcode of the product to be transferred, which will then automatically fill in the product information fields 1204-1210.

In the list 1214, the product can be individually removed by selecting a single line and clicking the Remove button 1220. Clicking the Save button 1222 performs a check to ensure that representative 1202 can receive the selected product 1204. If not, the transaction will not proceed beyond this point.

If the representative 1202 is able to receive the product 1204, then the Transfer Review screen 1230 is displayed (FIG. 13b). A list 1232 of all products to be transferred is shown. If all the information is accurate, clicking the Process button 1234 will continue the transaction. If there are any corrections to be made to any of the items in the list 1232, clicking the Transfer Info tab 1236 will return the user to the Rep. Transfer creation screen 1200 of FIG. 13a.

The transfer request process continues with notes entry screen 1240 (FIG. 13c). The user can enter any notes about the transfer request via the standard PDA input methods, which are displayed in a text box 1242. Clicking on the Signatures tab 1244 takes the user to the Signatures screen 1250 (FIG. 13d), and the last step of the transfer request creation process. Screen 1250 contains two signature capture boxes 1252, 1254 for the transferring representative and receiving representative, respectively, to place their signatures. Each capture box 1252, 1254 has an associated Clear button 1256, 1258 which, when clicked, will erase the signature displayed in the respective capture box. After both representatives have signed their names, clicking the Save button 1260 completes the transfer creation and automatically returns the user to the Home page 310.

Reconciliation

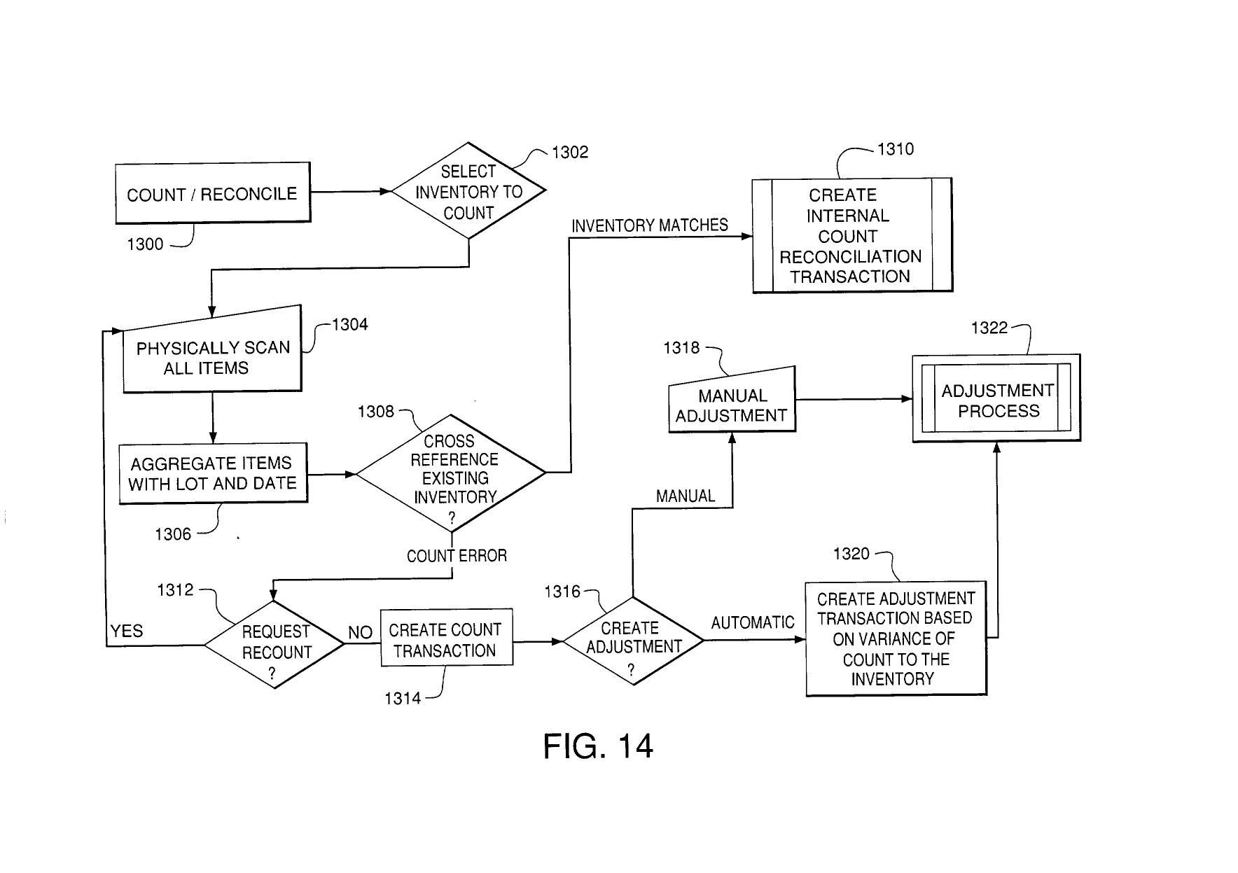

As in any business setting where there is inventory, it is occasionally necessary to perform a count of the inventory presently on hand. The method for a single representative to count his or her inventory is shown in FIG. 14. The process begins at step 1300 by initiating a count inventory transaction (also referred to herein as a reconciliation transaction). In step 1302, the inventory to be counted is chosen, and in step 1304 each of the items are scanned with the barcode reader attached to the user's PDA. The PDA automatically aggregates the items with the same lot number and expiration date in step 1306.

The physical inventory count is cross-referenced against the existing inventory in step 1308. If the count matches the existing inventory, then the inventory count is recorded in step 1310 and the process terminates. If the count does not match the existing inventory, the user is prompted whether he or she wants to request a recount of the inventory in step 1312. If the user requests a recount, the process returns to step 1304 for the recounting of each item.

If the user declines a recount, a count transaction is created (step 1314), and the user is prompted whether he or she wants to create a manual or an automatic inventory adjustment (step 1316). If the user selects a manual adjustment, she will enter the quantity by which the inventory will be adjusted in step 1318. If the user chooses an automatic adjustment, an adjustment transaction will be created with the adjustment quantity equal to the difference between the physical count and the existing inventory (step 1320). Regardless of the type of adjustment to be performed, the process then continues with an adjustment transaction in step 1322, which will be discussed in greater detail below.

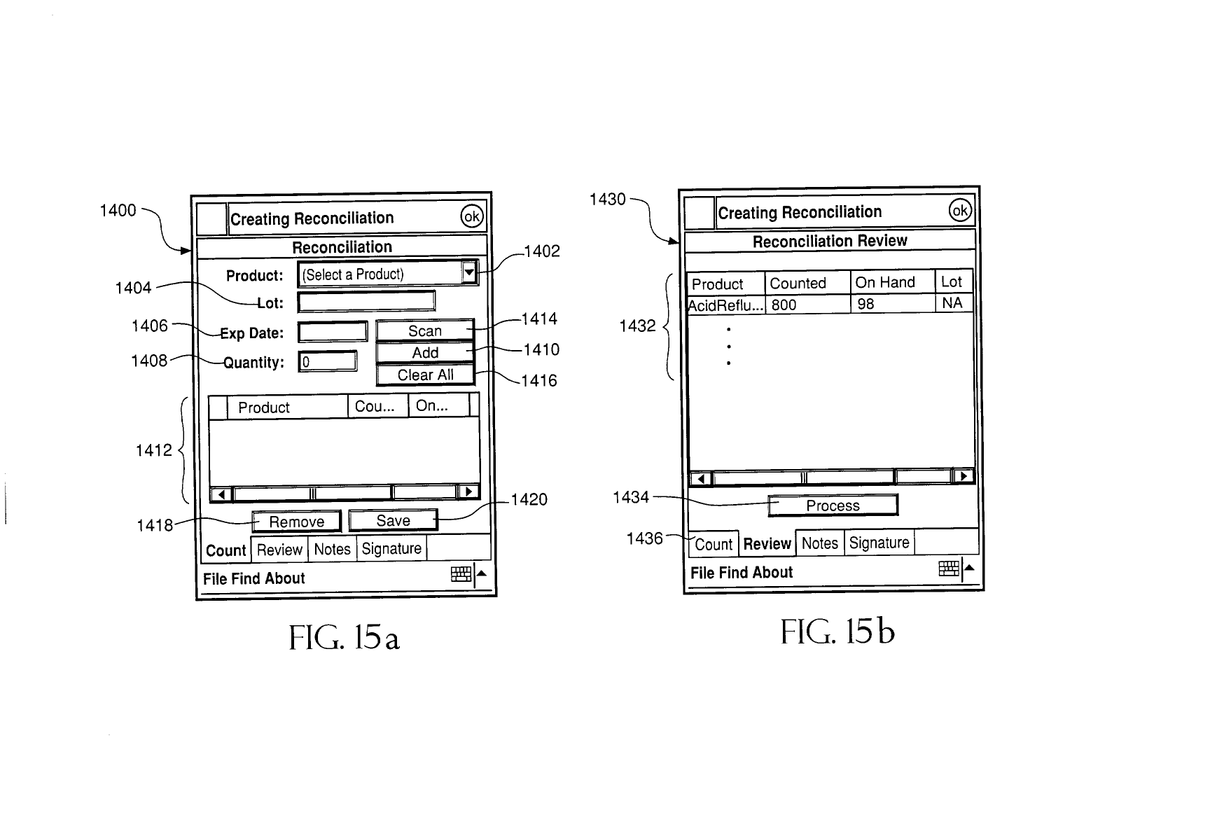

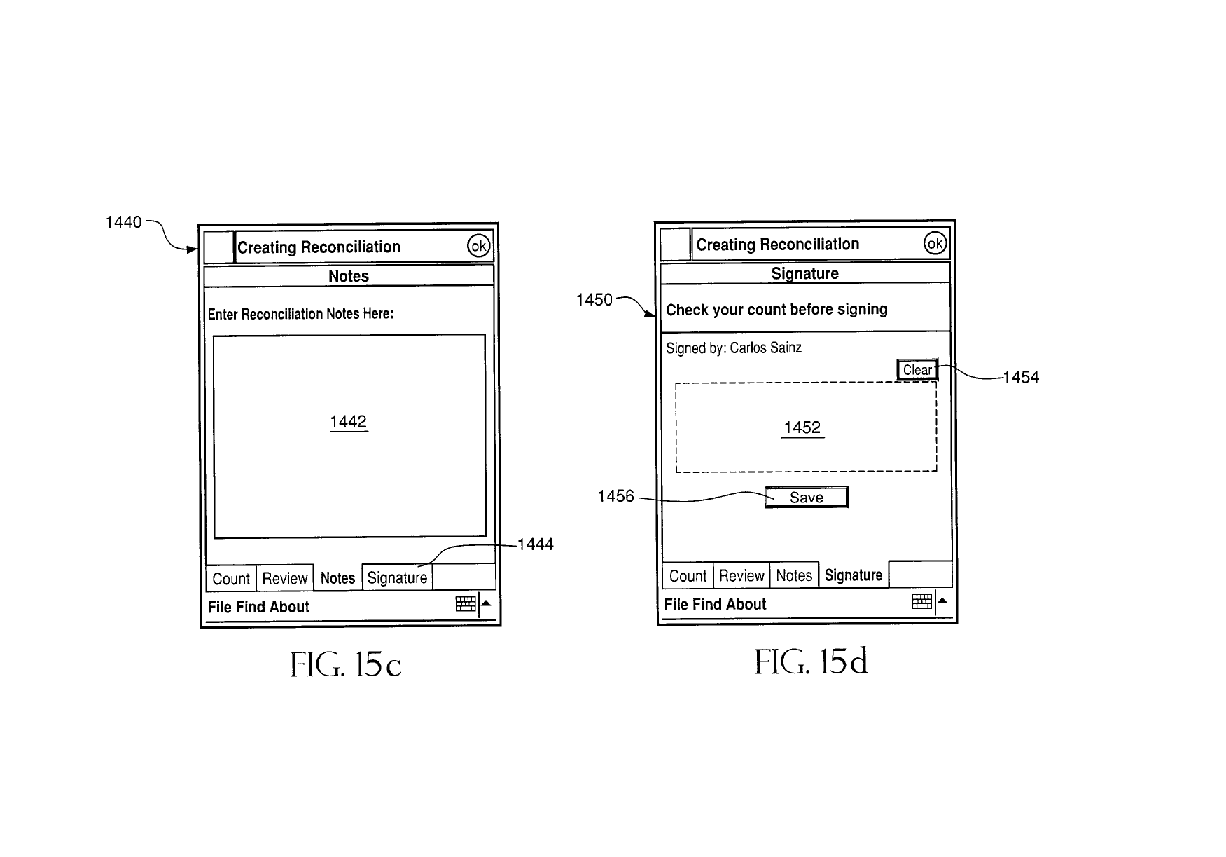

A user enters the reconciliation process by choosing Inventory->Reconcile Inventory from the menu bar 314 on the Home page 310, and which is illustrated in FIGS. 15a-15d. Referring to FIG. 15a, a Reconciliation create screen 1400 is used to select the product to be counted via a drop-down list 1402. The lot number 1404, expiration date 1406, and quantity 1408 can all be entered manually. Once this information is entered, clicking the Add button 1410 adds the product information to the product list 1412.

Alternately, clicking the Scan button 1414 will activate the attached barcode scanner, which allows the user to scan the barcode of the product, and will automatically populate the fields 1402-1408 after the system parses the barcode. If a product with the same lot number and expiration date has previously been added to the list 1412, scanning additional similar items will only increase the quantity shown in the list 1412, and will not create redundant list entries. Clicking the Clear All button 1416 will erase any data entered into the fields 1402-1408.

In the list 1412, a product can be individually removed by selecting a single line and clicking the Remove button 1418. Clicking the Save button 1420 completes the data entry step of the reconciliation transaction, and displays the Reconciliation Review screen 1430 (FIG. 15b). A list 1432 of all products that have been counted is shown. If all the information is accurate, clicking the Process button 1434 will continue the reconciliation process. If there are any corrections to be made to any of the items in the list 1432, clicking the Count tab 1436 will return the user to the Reconciliation create screen 1400 of FIG. 15a.

The reconciliation process continues with a Notes entry screen 1440 (FIG. 15c). The user can enter any notes about the product count via the standard PDA input methods, which are displayed in a text box 1442. Clicking on the Signature tab 1444 takes the user to the Signature screen 1450 (FIG. 15d). Screen 1450 contains a signature capture box 1452 for the representative to place his or her signature. The capture box 1452 has an associated Clear button 1454 which, when clicked, will erase the signature displayed in the capture box. After the representative has signed his or her name, clicking the Save button 1456 completes the reconciliation creation and enters the reconciliation process at step 1308 (FIG. 14). If during the system's processing of the reconciliation the user requests that a recount be performed, the entire transaction is cleared and the user restarts the process from the Reconciliation create screen 1400 (FIG. 15a). Any products in the user's inventory that are not physically counted will have a zero count record inserted into the database.

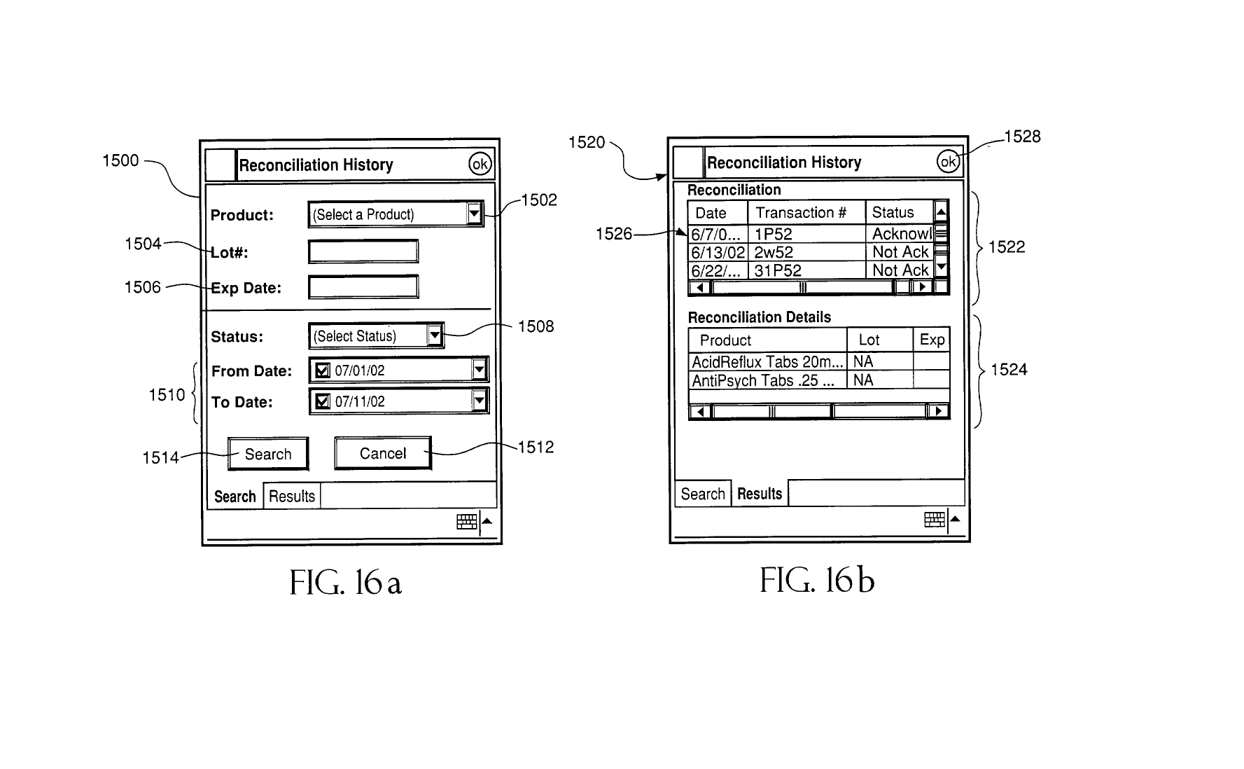

By selecting View->Reconcile History from the menu bar 314 on the Home page 310, the user can review the history and status of his or her inventory counts, as shown in FIGS. 16a and 16b. The Reconciliation History search screen 1500 (FIG. 16a) permits the user to enter criteria to search the database for specific product counts. The user can select the desired product from a drop-down list 1502, along with the lot number 1504 and expiration date 1506. The user can also search based upon the status of the reconciliation (e.g., acknowledged, not acknowledged), selected from drop-down list 1508, or the date range 1510 for the count. All of the fields 1502-1510 are optional; the user can search the reconciliation history based upon any desired combination of criteria. Clicking the Cancel button 1512 will clear any information entered into the fields 1502-1510. When the user has specified the desired criteria, clicking the Search button 1514 will execute the search in the database.

The results of the search are displayed in a Reconciliation History Details screen 1520 (FIG. 16b), consisting of a header section 1522 and a detail section 1524. The header section 1522 displays general information about all of the product counts matching the search criteria. Selecting an individual entry 1526 displays the details of that product count in the detail section 1524. The user can return to the home page 310 by clicking on the “OK” button 1528.

Adjustments

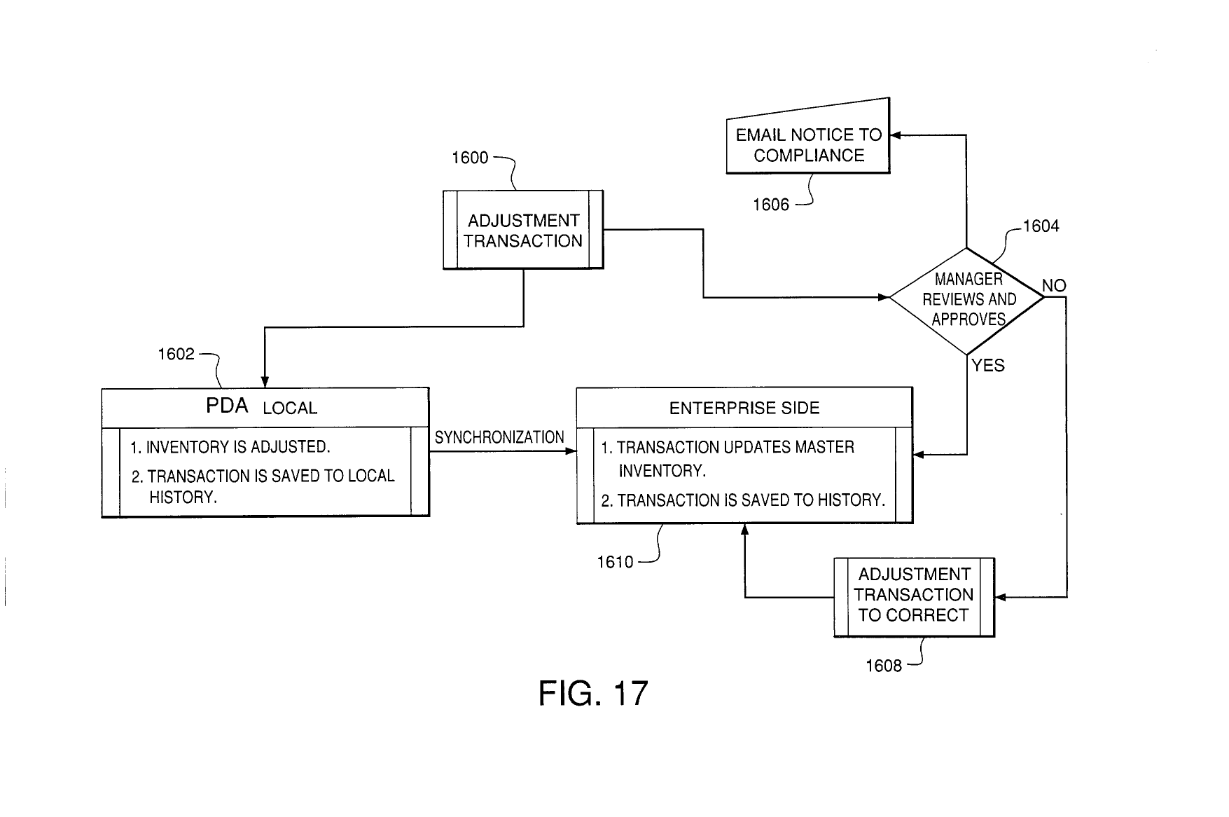

When, during the reconciliation process, an adjustment is necessary (see discussion above in connection with FIG. 14), the adjustment process shown in FIG. 17 is executed. The adjustment transaction is created at step 1600, and is recorded in the representative's PDA at step 1602, which also makes the adjustment to the representative's local inventory. The adjustment must be acknowledged by the representative's manager (step 1604) and the compliance department is notified of the adjustment transaction in step 1606. If the adjustment is acknowledged, the transaction is recorded in the master database (step 1610). If the manager disagrees with the adjustment, the manager will create an adjustment transaction to correct the user's adjustment (step 1608), and the manager's adjustment transaction is recorded in the master database (step 1610).

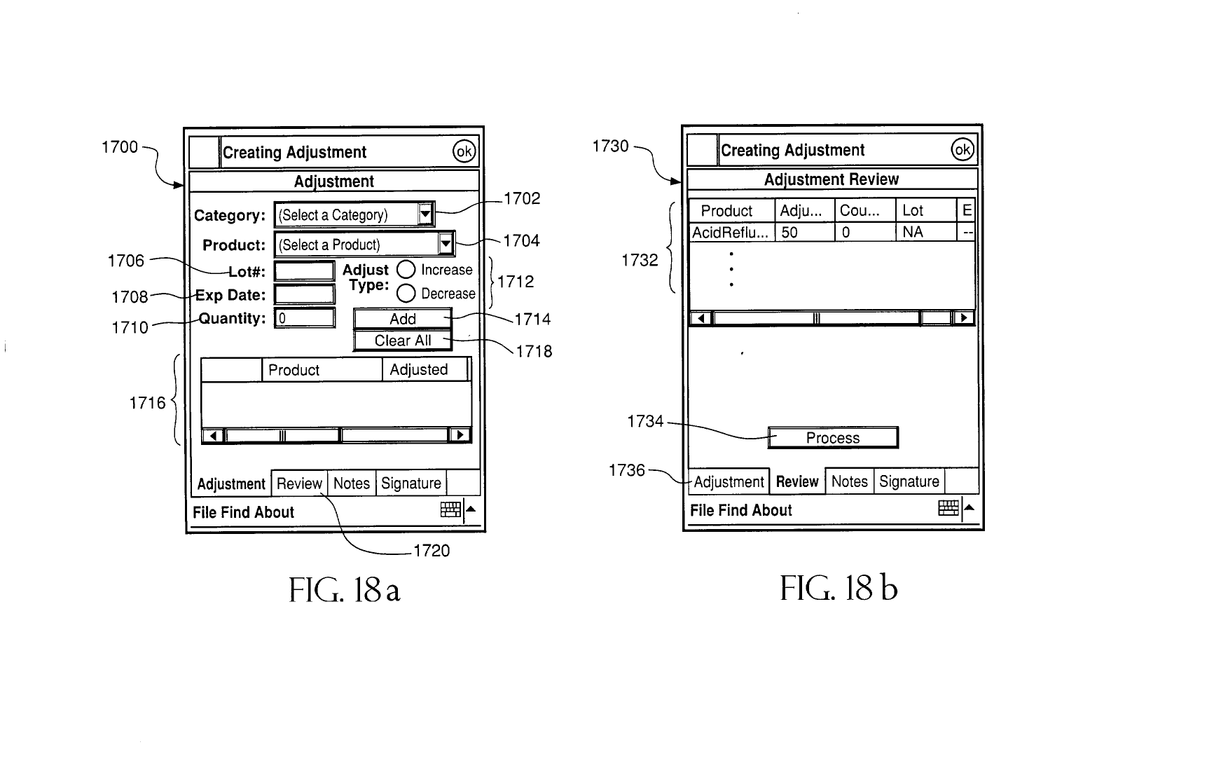

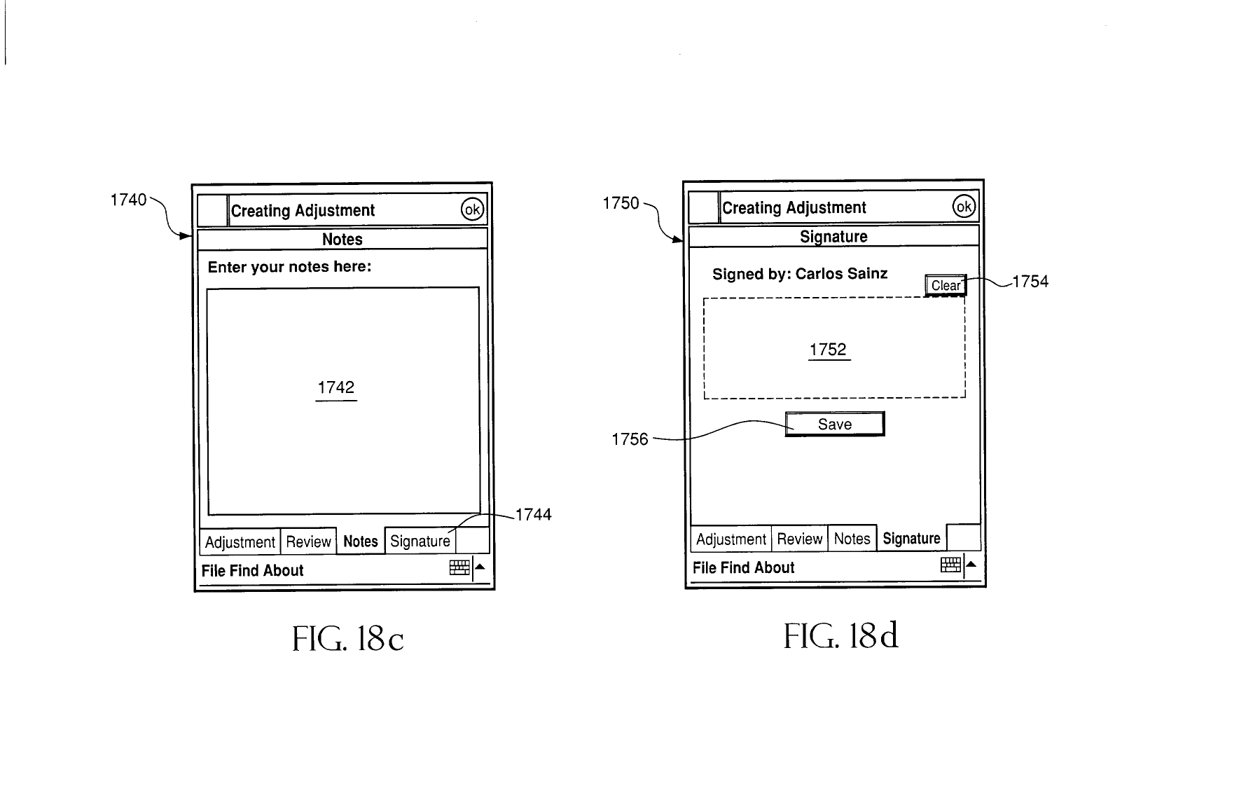

A user enters the adjustment process by choosing Inventory->Adjust Inventory from the menu bar 314 on the Home page 310, as illustrated in FIGS. 18a-18d. Alternately, the user can enter the adjustment process automatically during the processing of an inventory count. Referring to FIG. 18a, an Adjustment creation screen 1700 is used to enter the information regarding a specific inventory adjustment.

The user selects an adjustment category (e.g., reconciliation, replenishment, new inventory, lost, stolen) from a drop-down list 1702 and the product to be adjusted from a drop-down list 1704. The product list 1704 is populated based upon the category 1702 selected by the user, automatically filtering the product list to only include those items relevant to the selected category. Then user then manually enters the lot number 1706, expiration date 1708, and the adjustment quantity 1710. The type of adjustment to be made, either an increase or a decrease, is selected by clicking the appropriate radio button 1712. When the information has been entered, clicking the Add button 1714 places the information into a list 1716, showing all of the adjustment transactions entered. Clicking the Clear All button 1718 erases any data entered into the fields 1702-1712.

After the user has entered all of the adjustment transactions, clicking the Review tab 1720 takes the user to the Adjustment Review screen 1730 (FIG. 18b). A list 1732 of all the products to be adjusted is shown. If the information is accurate, clicking the Process button 1734 will continue the adjustment process. If there are any corrections to be made to any of the items in the list 1732, clicking the Adjustment tab 1736 will return the user to the Adjustment creation screen 1700.

The adjustment process continues with Notes entry screen 1740 (FIG. 18c). The user can enter any notes about the adjustment via the standard PDA input methods, which are displayed in a text box 1742. Clicking on the Signature tab 1744 takes the user to the Signature screen 1750 (FIG. 18d). Screen 1750 contains a signature capture box 1752 for the representative to place his or her signature. The capture box 1752 has an associated Clear button 1754 which, when clicked, will erase the signature displayed in the capture box. After the representative has signed his or her name, clicking the Save button 1756 completes the adjustment creation and enters the adjustment process at step 1600 (FIG. 17).

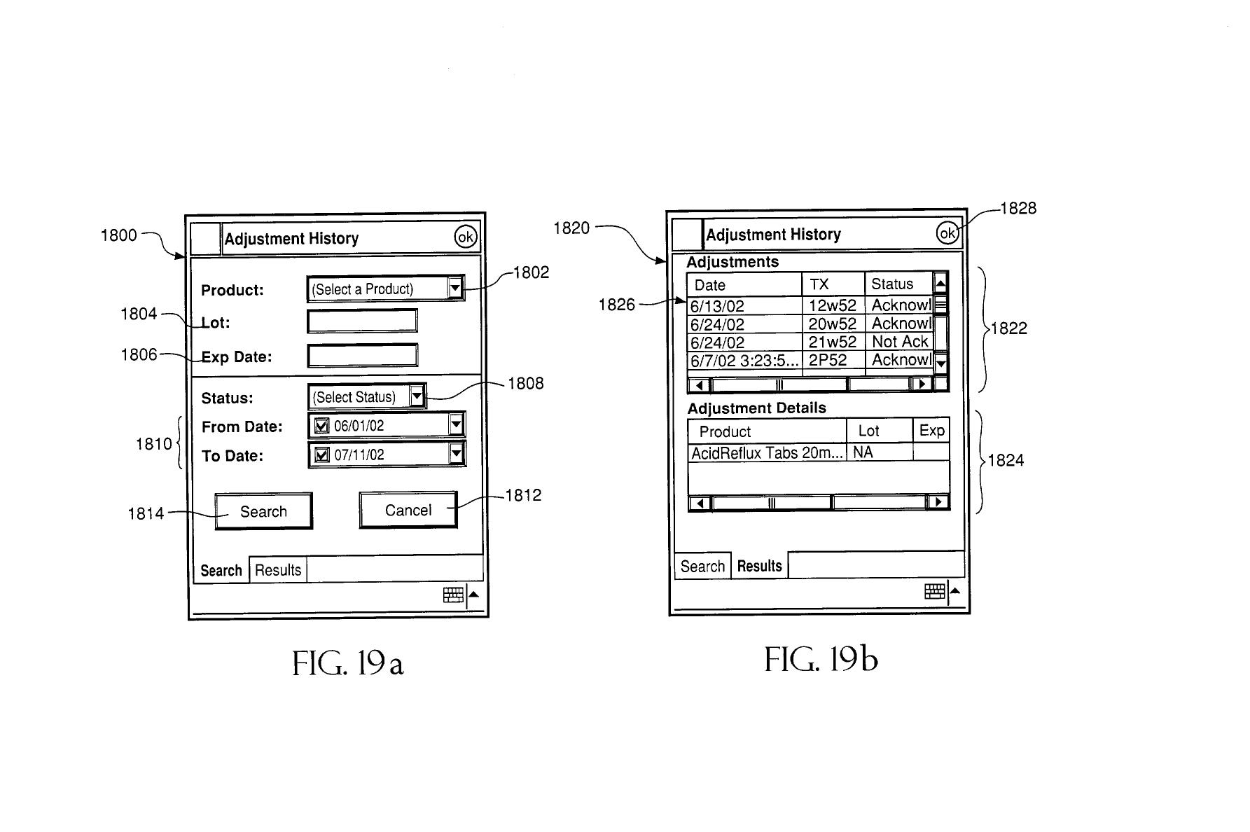

By selecting View->Adjustment History from the menu bar 314 on the Home page 310, the user can review the history of his or her adjustments, as shown in FIGS. 19a and 19b. The Adjustment History search screen 1800 (FIG. 19a) is used to enter criteria to search the database for specific adjustment transactions. The user can select the desired product from a drop-down list 1802, along with the lot number 1804 and expiration date 1806. The user can also choose the status of the adjustment (e.g., acknowledged, not acknowledged) from drop-down list 1808 or a date range 1810 for the adjustment transaction. All of the fields 1802-1810 are optional; the user can search the adjustment history based upon any desired combination of criteria. Clicking the Cancel button 1812 will clear any information entered into the fields 1802-1810. When the user has specified the desired criteria, clicking the Search button 1814 will execute the search in the database.

The results of the search are displayed in an Adjustment History details screen 1820 (FIG. 19b), consisting of a header section 1822 and a detail section 1824. The header section 1822 displays general information about all of the adjustment transactions matching the search criteria. Selecting an individual entry 1826 displays the details of that adjustment in the detail section 1824. The user can return to the home page 310 by clicking on the “OK” button 1828.

It will be understood that the embodiment described herein is merely exemplary and that a person skilled in the art may make many variations and modifications without departing from the spirit and scope of the present invention. For example, the system described above can also be used in connection with a pharmaceutical company representative distributing promotional items, such as shirts, golf balls, and the like. The procedures used for distributing the promotional items are substantially the same as for distributing pharmaceutical products, including signature capture during certain transactions. The main difference being that some of the information required to be gathered in connection with samples (e.g., lot number, expiration date) is not required for the promotional items, and the information screens will differ accordingly.

Furthermore, it is to be noted that the same functionality described above in connection with a PDA-based system can also be implemented in a Web-based system. The Web-based system provides additional administrative functions (mainly managerial functions, such as adding representatives to the system, associating representatives with HCPs, and the like) not found in the PDA-based system. All such variations and modifications are intended to be included within the scope of the invention as defined in the appended claims.

What is claimed is:

1. A method for managing a main inventory of items across a distributed mobile work force, wherein each worker has a mobile computing device, comprising the steps of:
receiving a sub-inventory from the main inventory and recording the sub-inventory on the mobile computing device;
disbursing the sub-inventory from a mobile worker to a consumer and updating the sub-inventory on the mobile computing device;
replenishing the sub-inventory from items in the main inventory and updating the sub-inventory on the mobile computing device;
counting the items in the sub-inventory and comparing the result of the physical count with a count stored on the mobile computing device;
transferring items from one sub-inventory to a second sub-inventory utilizing the workers' respective mobile computing devices; and
synchronizing the mobile computing device with a main database, which stores a list of the main inventory, whereby the sub-inventory transactions performed on the mobile computing device are recorded in the main database and against the main inventory.

2. A method according to claim 1, wherein the mobile computing device includes a barcode reader and the receiving, disbursing, replenishing, and counting steps include scanning the barcode of the item to be added to or removed from the sub-inventory.

3. A method according to claim 1, wherein the mobile computing device includes a wireless communication device and the transferring step is performed by passing the information regarding the items moved from one sub-inventory to the second sub-inventory from one mobile computing device to a second mobile computing device wirelessly.

4. A method according to claim 3, wherein the wireless communication device includes an infrared port.

5. A method according to claim 1, wherein the receiving step further includes capturing a signature on the mobile computing device for verifying the receiving transaction.

6. A method according to claim 1, wherein the disbursing step further includes capturing a signature on the mobile computing device for verifying the disbursement transaction.

7. A method according to claim 1, wherein the replenishing step further includes creating an automatic replenishment order based upon the worker's prior replenishment and disbursement history.

8. A method according to claim 7, wherein the creating step is accessible via a single button on the mobile computing device.

9. A method according to claim 1, wherein the counting step further includes capturing a signature on the mobile computing device for verifying the count transaction.

10. A method according to claim 1, wherein the transferring step further includes capturing a signature on the mobile computing device for verifying the transfer transaction.

11. A method according to claim 1, further comprising the step of capturing a signature on the mobile computing device for verifying a transaction involving the sub-inventory.

12. A method according to claim 1, further comprising the step of reviewing transactions previously performed on the sub-inventory.

13. A method according to claim 1, further comprising the step of generating an automatic order based upon a consumer's prior order history.

14. A method according to claim 13, wherein the generating step is accessible via a single button on the mobile computing device.

15. A method for automatically tracking the distribution of a pharmaceutical product sample, comprising the steps of:
marking the sample with an automatic identification code;
scanning the sample with a scanning device to read the automatic identification code a first time when a pharmaceutical company representative receives the sample from a pharmaceutical company;
scanning the sample with the scanning device to read the automatic identification code a second time when the pharmaceutical company representative provides a health care provider with the sample;
capturing the health care provider's signature on the scanning device; and
synchronizing the scanning device with a central database to track the sample from the pharmaceutical company to the health care provider.

16. A method for automatically tracking the distribution of a pharmaceutical product sample, comprising the steps of:
labeling the sample with a barcode;
scanning the barcode with a scanning device a first time when a pharmaceutical company representative receives the sample from a pharmaceutical company;
scanning the barcode with the scanning device a second time when the pharmaceutical company representative provides a health care provider with the sample;
capturing the health care provider's signature on the scanning device; and
synchronizing the scanning device with a central database to track the sample from the pharmaceutical company to the health care provider.

17. A system for automatically tracking the distribution of a pharmaceutical product sample, comprising:
an automatic identification code attached to a container for the sample;
a scanning device, including means for scanning said automatic identification code and means for capturing a signature; and
synchronizing means for synchronizing said scanning device with a central database.

18. A system according to claim 17, wherein said automatic identification code is a barcode and said scanning device is a barcode reader.

19. A system according to claim 17, wherein said automatic identification code is a magnetic stripe and said scanning device is a magnetic stripe reader.

20. A system according to claim 17, wherein said automatic identification code is a radio frequency identification tag and said scanning device is a radio frequency receiver.

21. A system according to claim 17, wherein said scanning device is attached to a personal digital assistant and said synchronizing means includes connecting the personal digital assistant to a computer that is connected to the central database.
